(19) United States
(12) Patent Application Publication
(10) Pub. No.: US 2019/0270067 A1
(43) Pub. Date: Sep. 5, 2019

(54) COMPOSITE FILTER AIDS AND METHODS OF USING COMPOSITE FILTER AIDS

(71) Applicant: IMERYS USA, INC., Roswell, GA (US)

(72) Inventor: Bo WANG, Union City, CA (US)

(21) Appl. No.: 16/346,239

(22) PCT Filed: Oct. 30, 2017
(86) PCT No.: PCT/US17/58986

§ 371 Date: Apr. 30, 2019

Related U.S. Application Data
(60) Provisional application No. 62/415,195, filed on Oct. 31, 2016.

(51) Int. Cl. B01J 20/14; B01J 20/12; B01J 20/10; B01J 20/28; B01D 37/02

(52) U.S. Cl. CPC B01J 20/14; B01J 20/12; B01J 20/106; B01J 20/28011; C12H 1/04; B01J 20/28059; B01J 20/28076; B01J 20/28085; B01D 37/02; B01J 20/2803

(57) ABSTRACT

This disclosure describes a composite filter aid containing a structured composite material formed by agglomerating an mineral with a protein-adsorbing binder, in which structured composite material includes a particle of the protein-adsorbing binder bonded to a plurality of particles of the mineral, and a permeability of the structured composite material is greater than permeabilities of both of the mineral and the protein-adsorbing binder. Also disclosed herein are processes for making composite filter aids and filtering methods using the composite filter aids.

### CLAIM FOR PRIORITY

This PCT International Application claims the benefit of priority of U.S. Provisional Application No. 62/415,195, filed Oct. 31, 2016, the subject matter of which is incorporated herein by reference in its entirety.

### FIELD OF DISCLOSURE

This application relates to materials technology in general and more specifically to the preparation and use of composite filter aids having improved properties relative to conventional filter aids. More particularly, this application discloses composite filter aids containing structured composite materials capable of exhibiting both high permeability and high protein-adsorption.

### BACKGROUND OF THE INVENTION

A “filter aid” is an inert material that can be used to improve filtration processes. Filter aids are generally used in two different ways—in a pre-coating method and in a body feeding method. Some filtering methods employ a combination of pre-coating and body feeding.

In a “pre-coating” method, the filter aid is initially applied to a filter element before a fluid to be filtered is applied to the filter element. For example, pre-coating may involve preparing a slurry containing water and a filter aid, and then introducing the slurry into a stream flowing through a filter element or septum. During the pre-coating process, a thin layer (e.g., 1.5-3.0 mm) is deposited onto the surface of the filtering element or septum. This will prevent or reduce gelatinous solids from plugging the filter element or septum during a subsequent filtration process—often providing a clearer filtrate.

In a “body feeding” method, the filter aid is introduced into a fluid to be filtered before the fluid reaches the filter element or septum. During filtration the filter aid material then follows the path of the unfiltered fluid and eventually reaches the filter element or septum. Upon reaching the filter element or septum, the added filter aid material will bind to a filter cake covering the filter element or septum. This can increase the porosity of the filter cake and may cause the filter cake to swell and thicken—increasing the permeability of the filter cake during filtration and possibly increasing the capacity of the filter cake.

Filter aids may include one or more material such as an inorganic powder or an organic fibrous material. Diatomaceous earth (DE) and natural glasses such as perlite, for example, are commonly employed as filter aids. Other minerals used as filter aids include mica, talc, bentonite, kaolin, smectite, wollastonite, and calcium carbonate. However, known filter aid materials such as commercial diatomaceous earths may suffer from any number of attributes that make them non-ideal or even inappropriate for certain filtration methods.

For instance, commercial diatomaceous earth in crude form generally exhibits a low permeability (e.g., 0.03 darcy)—such that use of a crude diatomaceous earth as a filter aid may lead to an excessively-high filtration pressure or premature filter clogging. Although modified diatomaceous filter aids such as calcined diatomaceous earths can offer significantly higher permeabilities relative to non-modified (crude) diatomaceous filter aids, they often possess significant quantities of crystalline silica minerals such as cristobalite and quartz. Crystalline silica minerals such as cristobalite are known carcinogens that can cause lung cancer in humans. Therefore, crystalline silica minerals may not be compatible in large-scale filtration processes or with filtration methods involving edible or potable substances.

Attempts to modulate the permeability of known filter aids by employing combinations of filter aid materials is often problematic due to the incompatible nature of filter aid materials. For instance, clay minerals such as bentonites, kaolins and smectites are known to act as binders that can reduce the permeability of porous diatomaceous minerals by blocking pores and reducing pore volumes when used in high clay concentrations. For this reason it is commonly known to employ mixtures of organic materials such as polymers with diatomaceous minerals in order to increase permeability of the resulting filtering aid. However, such mixtures are often less effective at reducing turbidity of filtered liquids due to the lower proportion of the diatomite mineral. It is also common to employ soda ash as a flux material to agglomerate diatomite particles during high-temperature calcination. However, the resulting agglomerates often exhibit low filtration efficiency due to the presence of fused diatomite particles having reduced porosity.

### SUMMARY OF THE INVENTION

The present inventors have recognized that a need exists to discover filter aids capable of improving filtration performance relative to conventional filter aids. Ideal filter aids would impart improved filtration performance in terms of increased permeability (reduced filtration pressure) and increased filter capacity—while at the same time offering other useful characteristics such as high protein adsorption and cation exchange capacity. Ideal filter aids would also be free of, or possess very low proportions of, crystalline silica minerals such as cristobalite.

The following disclosure describes the preparation and use of structured composite materials and composite filter aids that are effective in improving filtration performance relative to convention filter aids. Structured composite materials and composite filter aids disclosed and enabled herein are capable of imparting increased permeability and reduced filtration pressure to a wide variety of filtration processes. These materials may also exhibit increased protein adsorption characteristics and cation exchange capacity relative to convention filter aids—while minimizing or eliminating the presence of unwanted impurities such as crystalline silica compounds.

Embodiments of the present disclosure, described herein such that one of ordinary skill in this art can make and use them, include the following:
(1) Some embodiments relate to a composite filter aid, comprising a structured composite material formed by agglomerating an mineral with a protein-adsorbing binder, wherein: the structured composite material comprises a particle of the protein-adsorbing binder bonded to a plurality of particles of the mineral; a permeability of the structured composite material is greater than a permeability of the mineral; and the permeability of the structured composite material is greater than a permeability of the protein-adsorbing binder;
(2) Some embodiments relate to a structured composite material, comprising an mineral bound to a phyllosilicate, wherein a mass ratio of the phyllosilicate to the mineral is set such that: (i) a permeability of the structured composite material is greater than permeabilities of the mineral and the phyllosilicate; (ii) a d₅₀ of the structured composite material is greater than a d₅₀ of the mineral; (iii) a wet density of the structured composite material is less than a wet density of the mineral; and (iv) the structured composite material has a crystalline silica level of less than about 1% by weight;
(3) Some embodiments relate to a process for making the composite filter aid described in item (1) above, the process comprising: contacting a binder with a liquid to obtain a binder mixture; mixing the binder mixture with a composition comprising the mineral to obtain a mixed composite; and drying the mixed composite, to obtain the structured composite material;
(4) Some embodiments relate to a filtering method, comprising contacting a fluid with the composite filter aid described in item (1) above; and
(5) Some embodiments relate to a stabilized beverage obtained by performing the filtering method described in item (4) above on a beverage.

Additional objects, advantages and other features of the present disclosure will be set forth in part in the description that follows and in part will become apparent to those having ordinary skill in the art upon examination of the following or may be learned from the practice of the present disclosure. The present disclosure encompasses other and different embodiments from those specifically described below, and the details herein are capable of modifications in various respects without departing from the present invention. In this regard, the description herein is to be understood as illustrative in nature, and not as restrictive.

### BRIEF DESCRIPTION OF THE DRAWINGS

Embodiments of this disclosure are explained in the following description in view of figures that show:

FIG. 1 is a photograph of a calcium bentonite (Bavarian) obtained using a scanning electron microscope (SEM);

FIG. 2 is a SEM photograph of a structured composite material formed by agglomerating a diatomaceous earth with a calcium bentonite in the presence of sodium silicate as binder;

FIG. 3 is a SEM photograph of a structured composite material formed by agglomerating a diatomaceous earth with a calcium bentonite;

FIG. 4 is a SEM photograph of a structured composite material formed by agglomerating a perlite with a calcium bentonite;

FIG. 5 is a SEM photograph of a structured composite material formed by agglomerating a perlite with a calcium bentonite;

FIG. 6 is a SEM photograph of a structured composite material formed by agglomerating a perlite with a calcium bentonite;

FIG. 7 is a graph depicting pressure versus filtration time for the composite filter aid of Example 11 and a Standard Super-Cel® diatomaceous earth;

FIG. 8 is a graph depicting turbidity versus filtration time for the composite filter aid of Example 11 and a Standard Super-Cel® diatomaceous earth;

FIG. 9 is a graph depicting pressure versus filtration time for the composite filter aid of Example 15 and a Hyflo Super-Cel® diatomaceous earth; and

FIG. 10 is a graph depicting turbidity versus filtration time for the composite filter aid of Example 15 and a Hyflo Super-Cel® diatomaceous earth.

### DETAILED DESCRIPTION

Embodiments of this disclosure includes various processes for producing structured composite materials and composite filter aids, as well as compositions relating to these processes. Methods of using composite filter aids, as well as products obtained from these methods, are also disclosed herein.

### Composite Filter Aid Comprising a Structured Composite Material

Some embodiments relate to composite filter aids comprising a structured composite material formed by agglomerating a mineral with a protein-adsorbing binder. As used herein, the phrase “structured composite material” refers to a material comprising a particle of the protein-adsorbing binder bonded to a plurality of particles of the mineral. In some embodiments the structured composite material is formed using a composition and manner such that a permeability of the structured composite material is greater than permeabilities of the mineral and the protein-adsorbing binder.

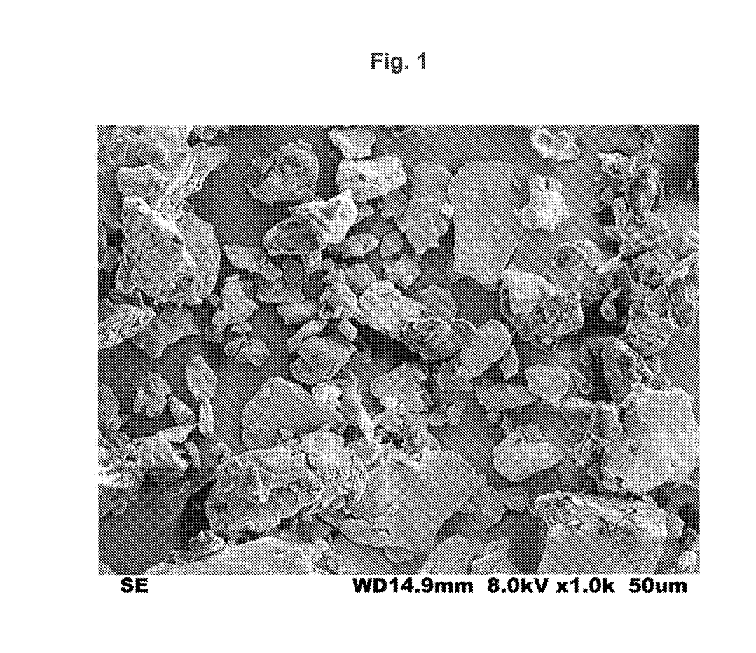

In some embodiments the composite filter aid comprises a structured composite material having a core-and-shell structure, in which the structured composite material comprises a core comprising the particle of the protein-adsorbing binder, and the core is at least partially covered by a shell comprising the plurality of particles of the mineral. Such core-and-shell structures are illustrated in FIGS. 1-6. In other embodiments the particles are integrated composite particles of, for example, a diatomaceous earth and a bentonite.

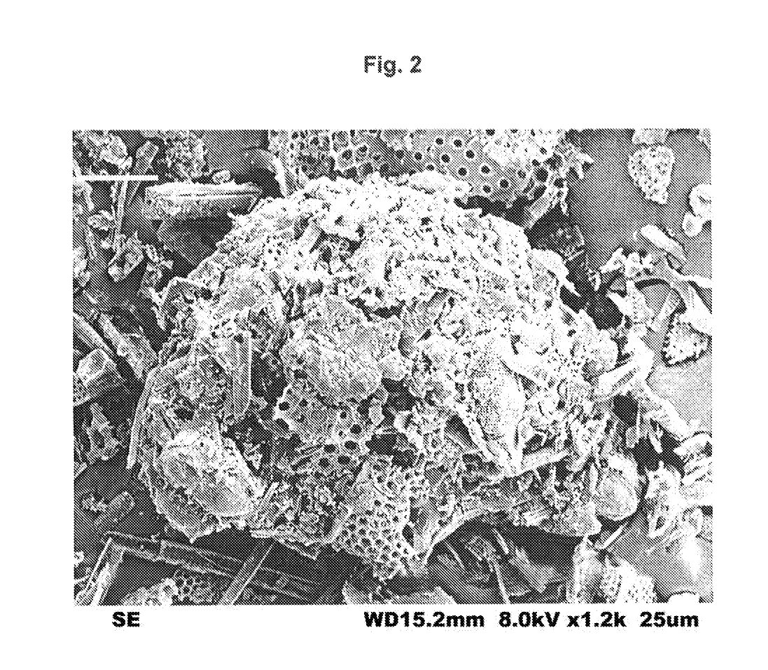

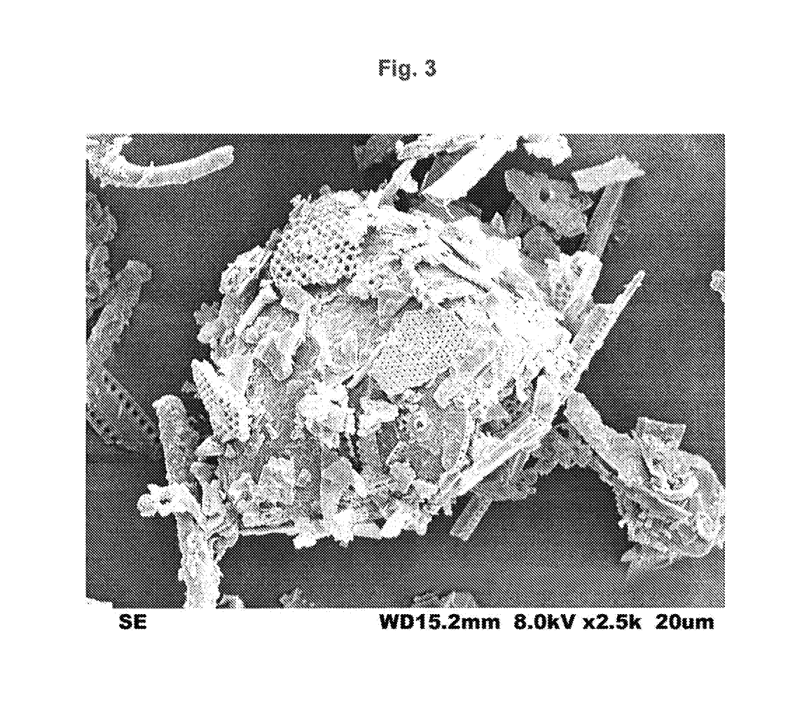

FIG. 1 is a SEM photograph of particles of a calcium bentonite binder material used in some embodiments as the protein-adsorbing binder. FIG. 2 is a SEM photograph showing one embodiment of a structured composite material formed by agglomerating a diatomaceous earth with the calcium bentonite binder material shown in FIG. 1. As illustrated in FIG. 2, the structured composite material of this example includes a core of the protein-adsorbing binder (calcium bentonite) covered by a shell of a plurality of particles of the mineral (a porous diatomaceous earth). FIG. 3 illustrates another embodiment of a structured composite material in which the mass ratio of the protein-adsorbing binder (calcium bentonite) to the mineral (diatomaceous earth) is increased relative to the mass ratio of the structured composite mineral in FIG. 2. In FIG. 3 the surface of the protein-adsorbing core is visible and is surrounded by a shell containing a plurality of particles of the mineral.

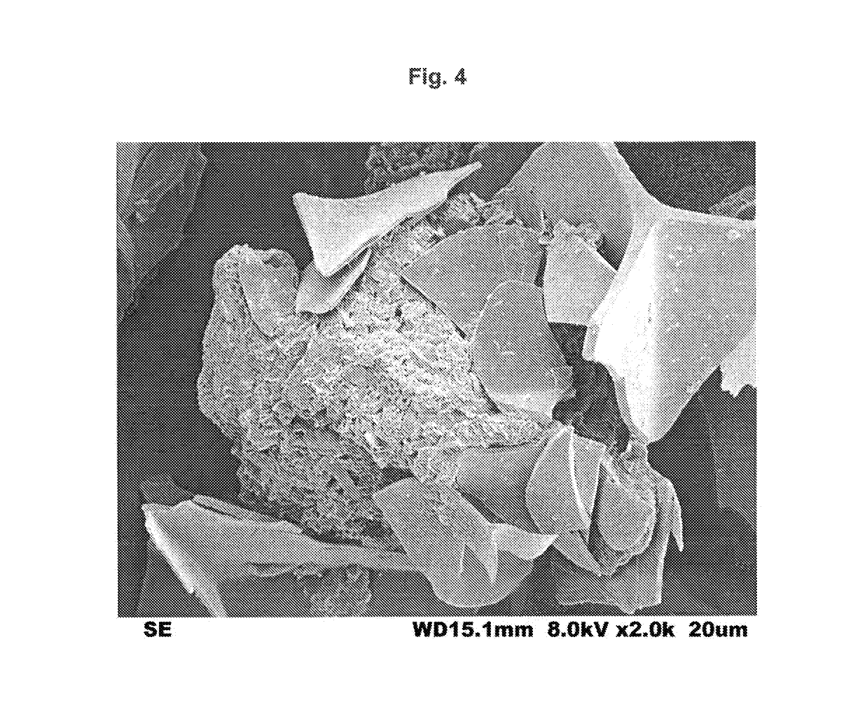

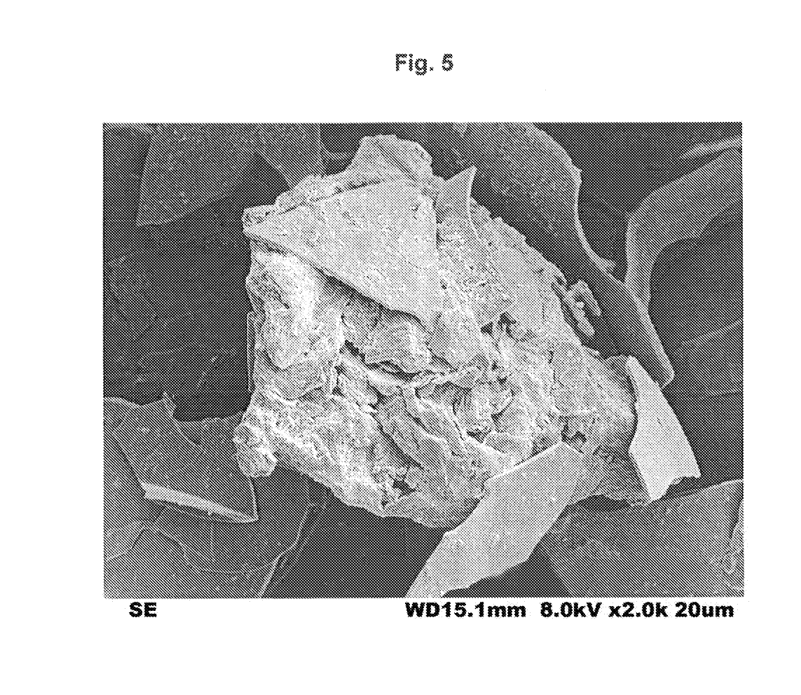

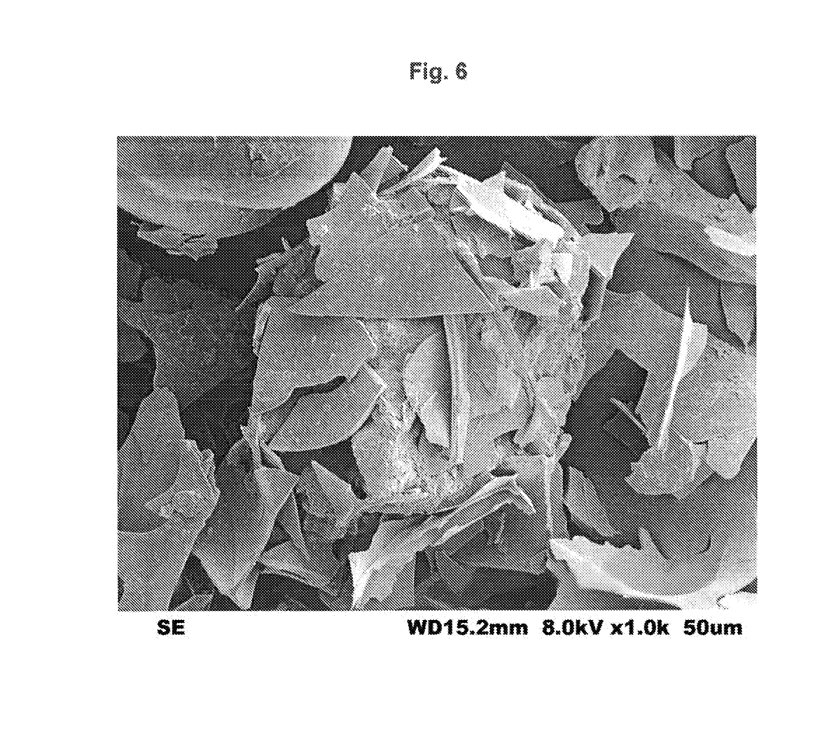

FIGS. 4-6 are SEM photographs showing other embodiments of structured composite materials formed by agglomerating a perlite mineral with the calcium bentonite binder material shown in FIG. 1. As illustrated in FIGS. 4 and 5, the structured composite materials of these examples include a core of the protein-adsorbing binder (calcium bentonite) covered by a shell of a plurality of particles of the mineral (perlite). FIG. 6 illustrates another embodiment of a structured composite material in which the mass ratio of the protein-adsorbing binder (calcium bentonite) to the mineral (perlite) is decreased relative to the mass ratio of the structured composite materials in FIGS. 4 and 5. In FIG. 6 the surface of the protein-adsorbing core is less visible compared to the protein-adsorbing cores of FIGS. 4 and 5 due to the increased coverage rate of the core with the shell comprising the plurality of perlite particles.

In some embodiments a coverage rate of the mineral (shell) on the surface of the protein-adsorbing binder (core) ranges from about 10% to about 99%, based on the entire surface of the structured composite material being 100%. In other embodiments the coverage rate of the mineral on the surface of the protein-adsorbing binder ranges from about 50% to about 95%. In still other embodiments a coverage rate of the mineral on the surface of the protein-adsorbing binder ranges from about 75% to about 90%.

In some embodiments the “mineral” refers to a non-crystalline (amorphous) mineral, whereas in other embodiments the “mineral” refers to a crystalline mineral. In some embodiments the mineral is a biogenic mineral, a natural glass, or a mixture thereof.

The expression “biogenic mineral” refers to a mineral produced by life processes such as, for example, minerals produced as either constituents or secretions of plants or animals. In some embodiments the mineral is a biogenic mineral selected from a mineral carbonate, a mineral phosphate, a mineral halide, a mineral oxalate, a mineral sulfate, a mineral silicate, an iron oxide, a manganese oxide, an iron sulfide, and mixtures thereof. For example, the mineral may be a biogenic mineral selected from a diatomite such as a natural diatomaceous earth, a modified diatomaceous earth, and mixtures thereof.

As used herein, the term “natural diatomaceous earth” refers to any diatomaceous earth material that has not been subjected to thermal treatment (e.g., calcination) sufficient to induce formation of greater than 1% cristobalite.

A natural diatomaceous earth is, in general, a sedimentary biogenic silica deposit including the fossilized skeletons of diatoms which are single-cell algae-like plants that accumulate in marine or fresh water environments. Honeycomb silica structures generally impart diatomaceous earths with useful characteristics such as high absorptive capacity and surface area, chemical stability, and low-bulk density. In some embodiments the mineral may be a natural diatomaceous earth containing about 90% of silica (SiO₂) mixed with other substances. In some embodiments the mineral may be a crude diatomaceous earth containing about 90% of silica (SiO₂) with various metal oxides such as, by illustration, oxides of Al, Fe, Ca and Mg.

In some embodiments the mineral is a natural diatomaceous earth that has not been subjected to a thermal treatment. In other embodiments the mineral is a diatomaceous earth material that has not been subjected to calcination. In some embodiments the average particle size for diatomaceous earth minerals may range from 5 to 200 microns, their surface areas may range from 1 to 80 m²/g, their pore volumes may range from 2 to 10 L/mg, and their median pore sizes may range from 1 to 20 microns. However, minerals of the present disclosure are not limited to diatomaceous earth minerals having those characteristics.

Particle size may be measured by any appropriate measurement technique now known to the skilled artisan or hereafter discovered. In one exemplary method, particle size and particle size properties, such as particle size distribution (“psd”), are measured using a Leeds and Northrup Microtrac X100 laser particle size analyzer (Leeds and Northrup, North Wales, Pa., USA), which can determine particle size distribution over a particle size range from 0.12 micrometers (μm or microns) to 704 μm. The size of a given particle is expressed in terms of the diameter of a sphere of equivalent diameter that sediments through the suspension, also known as an equivalent spherical diameter or “esd.” The median particle size, or d₅₀ value, is the value at which 50% by weight of the particles have an esd less than that d₅₀ value. The d₁₀ value is the value at which 10% by weight of the particles have an esd less than that d₁₀ value. The d₉₀ value is the value at which 90% by weight of the particles have an esd less than that d₉₀ value.

BET surface area, as used herein, refers to the technique for calculating specific surface area of physical absorption molecules according to Brunauer, Emmett, and Teller (“BET”) theory. BET surface area may be measured by any appropriate measurement technique now known to the skilled artisan or hereafter discovered. In one exemplary method, BET surface area is measured with a Gemini III 2375 Surface Area Analyzer, using pure nitrogen as the sorbent gas, from Micromeritics Instrument Corporation (Norcross, Ga., USA).

The mineral of the present disclosure may also include a diatomaceous earth material that has been subjected to at least one thermal treatment such as, for example, a diatomaceous earth material that has been subjected to calcination. Examples of calcined diatomaceous earths include non-flux calcined or flux-calcined diatomaceous earths.

Diatomaceous earth minerals that may be used as the mineral may have any of various appropriate forms known to the skilled artisan or hereafter discovered. In some embodiments the mineral may be a natural diatomaceous earth that is unprocessed (e.g., it is not subjected to chemical and/or physical modification processes). In some embodiments the natural diatomaceous earth may undergo minimal processing following mining or extraction. In some embodiments the natural diatomaceous earth may be subjected to at least one physical modification process. Some examples of possible physical modification processes include, but are not limited to, milling, drying, and classifying. In some embodiments the natural diatomaceous earth may be subjected to at least one chemical modification process. An example of a chemical modification processes is silanization, but other chemical modification processes are contemplated. Silanization may be used to render the surface of the diatomaceous earth either more hydrophobic or hydrophilic using the methods appropriate for silicate minerals.

In some embodiments the mineral may be a diatomaceous earth having a median particle size (d₅₀) ranging from about 10 microns to about 30 microns, may have a pore volume ranging from about 2 mL/g to about 4 mL/g, may have a median pore size ranging from about 1 microns to about 3 microns, may have a BET surface area ranging from about 10 m²/g to about 40 m²/g, and/or may have a bulk density ranging from about 4 lbs/ft³ to about 8 lbs/ft³. According to some embodiments the diatomaceous earth has a d₁₀ ranging from 7 to 20 microns, a d₅₀ ranging from 20 to 50 microns, and a d₉₀ ranging from 60 to 120 microns. In still other embodiments employing diatomaceous earth minerals, the dimensions may fall outside of the ranges enumerated above.

The term “natural glass” as used herein refers to natural glasses, such as volcanic glasses, that are formed by the rapid cooling of siliceous magma or lava. In some embodiments the mineral is a nature glass selected from a perlite, a volcanic ash, a pumice, a pumicite, a shirasu, an obsidian, a pitchstone, a rice hull ash, and mixtures thereof.

In some embodiments the mineral may be perlite containing, for example, about 72 to about 75% SiO₂, about 12 to about 14% Al₂O₃, about 0.5 to about 2% Fe₂O₃, about 3 to about 5% Na₂O, about 4 to about 5% K₂O, about 0.4 to about 1.5% CaO (by weight), and small amounts of other metallic elements.

According to some embodiments the mineral is a natural glass having a d₁₀ ranging from 10 to 20 microns, a d₅₀ ranging from 20 to 70 microns, and a d₉₀ ranging from 100 to 160 microns.

The mineral may include a mixture of minerals such as, for example, a mixture of a diatomaceous earth and a nature glass. In some embodiments the mineral is a mixture of a diatomaceous earth and a natural glass, wherein a ratio of the diatomaceous earth to the natural glass ranges from 1:99 to 99:1 by weight. For example, the ratio of the diatomaceous earth to the natural glass may range from 1:3 to 3:1 by weight.

In some embodiments the mineral is a surface-modified mineral. The surface chemistry of the mineral may affect the interaction between the protein-adsorbing binder and the mineral. The surface chemistry of the mineral may also affect the dispersibility of the structured composite material in the matrix of the composite filter aid. The surface chemistry of the mineral may also affect the filtration properties of the composite filter aid such as its permeability.

Surface-modifying agents may include, by non-limiting example, silicon-containing compounds such as silicones and silanes that may or may not contain additional functional groups such as alkylene groups, alkoxy groups, amino groups, aryl groups, carbamate groups, epoxy groups, ester groups, ether groups, halide groups, heteroaryl groups, sulfide and/or disulfide groups, hydroxyl groups, isocyanate group, nitrile groups, other ionic (charged) groups, and mixtures thereof.

As used herein, the phrase “protein-adsorbing binder” refers to any protein-adsorbing material or substance that holds or binds the mineral to form a structured composite material containing the mineral and the protein-adsorbing binder. The protein-adsorbing binder may hold or bind the mineral by any attractive phenomenon such as mechanically, chemically or as an adhesive.

In some embodiments the protein-adsorbing binder may be selected from a mica, a talc, a clay, a kaolin, a smectite, a wollastonite or a calcium carbonate, just to name a few. In some embodiments the protein-adsorbing binder may have a d₁₀ ranging from 1 to 200 microns, a median particle size (d₅₀) ranging from 10 to 70 microns, a top particle size (d₉₀) ranging from 100 to 120 microns, and an aspect ratio greater than 2, greater than 2.5, greater than 3, greater than 5, greater than 10, greater than 20, or greater than 50. In other embodiments the protein-adsorbing binder may have one or more dimensions falling outside of the ranges enumerated above.

The aspect ratio may be determined according to Jennings theory. The Jennings theory (or Jennings approximation) of aspect ratio is based on research performed by W. Pabst, E. Gregorova, and C. Berthold, Department of Glass and Ceramics, Institute of Chemical Technology, Prague, and Institut für Geowissenschaften, Universität Tübingen, Germany, as described, e.g., in Pabst W., Berthold C.: Part. Part. Syst. Charact. 24 (2007), 458.

In some embodiments the protein-adsorbing binder is a phyllosilicate mineral selected from a serpentine mineral, a clay mineral, a mica mineral and a chlorite mineral.

As used herein, the word “phyllosilicate” refers to silicate compounds existing as structured silicates often in the form of parallel sheets of silicate compounds. In some embodiments the protein-adsorbing binder is a phyllosilicate mineral selected from an antigorite (Mg₃Si₂O₅(OH)₄), a chrysotile (Mg₃Si₂O₅(OH)₄), a lizardite (Mg₃Si₂O₅(OH)₄), a halloysite (Al₂Si₂O₅(OH)₄), an kaolinite (Al₂Si₂O₅(OH)₄), an illite ((K,H₃O) (Al,Mg,Fe)₂ (Si,Al)₄O₁₀[(OH)₂.(H₂O)]), a montmorillonite ((Na,Ca)_{0.33} (Al,Mg)₂Si₄O₁₀(OH)₂.nH₂O), a vermiculite ((MgFe,Al)₃(Al,Si)₄O₁₀(OH)₂.4H₂O), a talc (Mg₃Si₄O₁₀(OH)₂), a sepiolite (Mg₄Si₆O₁₅(OH)₂.6H₂O), a palygorskite ((Mg,Al)₂Si₄O₁₀ (OH).4(H₂O)), an attapulgite ((Mg,Al)₂Si₄O₁₀ (OH).4(H₂O)), a pyrophyllite (Al₂Si₄O₁₀(OH)₂), a biotite (K(Mg,Fe)₃ (AlSi₃)O₁₀(OH)₂), a muscovite (KAl₂(AlSi₃) O₁₀(OH)₂), a phlogopite (KMg₃ (AlSi₃)O₁₀(OH)₂), a lepidolite (K(Li,Al)₂₋₃(AlSi₃) O₁₀(OH)₂), a margarite (CaAl₂ (Al₂Si₂)O₁₀(OH)₂), a glauconite ((K,Na) (Al,Mg,Fe)₂(Si,Al)₄O₁₀ (OH)₂), a chlorite ((Mg,Fe)₃(Si,Al)₄O₁₀(OH)₂.(Mg,Fe)₃ (OH)₆), or mixtures thereof.

For example, as described above by reference to FIGS. 1-6, in some embodiments the protein-adsorbing binder may be a bentonite mineral such as a sodium bentonite, a calcium bentonite, a potassium bentonite or a mixture thereof.

The structured composite material may also be formed by agglomerating the mineral with the protein-adsorbing binder and an additional binder that is different from the mineral and the protein-adsorbing binder. For example, the additional binder may be at least one additional binder selected from an inorganic binder and an organic binder. In some embodiments the structured composite material is formed using an additional binder that is at least one inorganic binder selected from a silicate, a cement and a clay. Examples of inorganic binders suitable for use as an additional binder include sodium silicate and potassium silicate.

In other embodiments the additional binder may be at least one organic binder, such as an organic binder selected from a cellulose, a polyethylene glycol (PEG), a polyvinyl alcohol (PVA), a polyvinylpyrrolidone (PVP), a starch, a silicone, a Candalilla wax, a polyacrylate, a polydiallyldimethylammonium chloride polymer, a dextrin, a lignosulfonate, a sodium alginate, a magnesium stearate, and mixtures thereof. For instance, the additional binder may include at least one organic binder selected from a linear silicon polymer, a ring-shaped silicone polymer and a resin silicone polymer.

When the protein adsorbing binder comprises bentonite, the structured composite material may also be formed by agglomerating the mineral with the protein-adsorbing binder during the acid activation process to make composite materials. For example, diatomite or perlite can be added to the bentonite prior to or during the acid activation process to produce the structured composite material.

Aside from the structured composite material, the composite filter aids of the present disclosure may also contain other materials such as filler materials. Filler materials may include organic and inorganic particulates and fibers. Examples of filler materials include silica, alumina, wood flour, gypsum, talc, mica, carbon black, montmorillonite minerals, chalk, diatomaceous earth, sand, gravel, crushed rock, bauxite, limestone, sandstone, aerogels, xerogels, microspheres, porous ceramic spheres, gypsum dihydrate, calcium aluminate, magnesium carbonate, ceramic materials, pozzolanic materials, zirconium compounds, xonotlite, (a crystalline calcium silicate gel), perlite, vermiculite, hydrated or unhydrated hydraulic cement particles, pumice, perlite, zeolites, kaolin, titanium dioxide, iron oxides, calcium phosphate, barium sulfate, sodium carbonate, magnesium sulfate, aluminum sulfate, magnesium carbonate, barium carbonate, calcium oxide, magnesium oxide, aluminum hydroxide, calcium sulfate, barium sulfate, lithium fluoride, polymer particles, powdered metals, pulp powder, cellulose, starch, chemically modified starch, thermoplastic starch, lignin powder, wheat, chitin, chitosan, keratin, gluten, nut shell flour, wood flour, corn cob flour, calcium carbonate, calcium hydroxide, glass beads, hollow glass beads, seagel, cork, seeds, gelatins, wood flour, saw dust, agar-based materials, reinforcing agents, such as glass fiber, natural fibers, such as sisal, hemp, cotton, wool, wood, flax, abaca, sisal, ramie, bagasse, and cellulose fibers, carbon fibers, graphite fibers, silica fibers, ceramic fibers, metal fibers, stainless steel fibers, and recycled paper fibers, for example, from repulping operations, just to name a few.

Composite filter aids of the present disclosure may also include co-filter aids such as polymer filter aids. Polymers that may be added as polymer filter aids include all polymers known in the field of field of filtering technology that are suitable as filter aids. Non-limiting examples of polymer filter aids that may be contained in composite filter aids of the present disclosure include polystyrenes, polyethylenes, polystyrenes, polyamides, polyesters, polyurethanes, poly(ethyl vinyl acetate)s, polyethylene terephthalates, and copolymers and blends thereof, just to name a few.

In some embodiments the relative proportions of the mineral and the protein-adsorbing binder can be adjusted to affect the properties of the structured composite material (and the resulting composition filter aid) such as the permeability, surface area, cation exchange capacity, protein adsorption, particle size, density and porosity—as well as the ability of filtering aid to modify or stabilize a filtered substance.

In some embodiments a mass ratio of the protein-adsorbing binder to the mineral ranges from about 0.01:99.99 to about 50:50. In other embodiments the mass ratio of the protein-adsorbing binder to the mineral ranges from about 0.01:99.99 to about 30:70, or from about 0.05:99.95 to about 10:90, or from about 0.1:99.9 to about 5:95, or from about 0.2:99.8 to about 3:97. In some embodiments the upper mass ratio may be limited by the permeability of the resulting structured composite material. However, in some cases the relative proportion (mass ratio) of the protein-adsorbing binder can be increased by including the additional binder as described above. Consequently, in some embodiments desirable properties such as protein adsorption and cation exchange capacity may be increased by including an additional binder that allows the proportion of the protein-adsorbing binder to be increased without causing a dramatic decrease in the permeability of the resulting structured composite material.

Composite filter aids of the present disclosure may have a permeability suitable for use in a filter aid composition. Permeability may be measured by any appropriate measurement technique now known to the skilled artisan or hereafter discovered. Permeability is generally measured in darcy units or darcy, as determined by the permeability of a porous bed 1 cm high and with a 1 cm² section through which flows a fluid with a viscosity of 1 mPa·s with a flow rate of 1 cm³/sec under an applied pressure differential of 1 atmosphere. The principles for measuring permeability have been previously derived for porous media from Darcy's law (see, for example, J. Bear, “The Equation of Motion of a Homogeneous Fluid: Derivations of Darcy's Law,” in Dynamics of Fluids in Porous Media 161-177 (2nd ed. 1988)). An array of devices and methods are in existence that may correlate with permeability. In one exemplary method useful for measuring permeability, a specially constructed device is designed to form a filter cake on a septum from a suspension of filtration media in water; and the time required for a specified volume of water to flow through a measured thickness of filter cake of known cross-sectional area is measured.

In some embodiments the composite filter aid has a permeability ranging from about 0.02 darcys to about 20 darcys. In some embodiments the composite filter aid has a permeability ranging from about 0.02 darcys to about 1 darcys, about 0.1 darcys to about 1 darcys, about 0.2 darcys to about 1 darcys, about 0.2 darcys to about 0.5 darcys, about 3 darcys to about 16 darcys, or from about 5 darcys to about 16 darcys, or from about 9 darcys to about 16 darcys, or from about 11 darcys to about 16 darcys.

According to some embodiments the composite filter aid has a BET surface area ranging from 3 m²/g to 70 m²/g.

Composite filter aids disclosed herein may have a measurable pore volume. Pore volume may be measured by any appropriate measurement technique now known to the skilled artisan or hereafter discovered. In one exemplary method, pore volume is measured with an AutoPore IV 9500 series mercury porosimeter from Micromeritics Instrument Corporation (Norcross, Ga., USA), which can determine measure pore diameters ranging from 0.006 to 600 μm. As used to measure the pore volume of the composite materials disclosed herein, that porosimeter's contact angle was set at 130 degrees, and the pressure ranged from 0 to 33,000 psi.

In some embodiments the pore volume of the composite filter aid ranges from about 2 mL/g to about 10 mug. In other embodiments the pore volume ranges from about 4 mL/g to about 8 mug, or from about 5 mL/g to about 7 mL/g.

Composite filter aids disclosed herein may have a measurable median pore diameter. Median pore diameter may be measured by any appropriate measurement technique now known to the skilled artisan or hereafter discovered. In one exemplary method, median pore diameter is measured with an AutoPore IV 9500 series mercury porosimeter, as described above.

In some embodiments the median pore diameter of the composite filter aids ranges from about 1 μm to about 40 μm. In other embodiments the median pore diameter ranges from about 2 μm to about 10 μm, or from about 3 μm to about 8 μm. In other embodiments the median pore diameter ranges from about 15 μm to about 30 μm, or from about 20 μm to about 30 μm.

In some embodiments the d₁₀ of the composite filter aid ranges from about 5 μm to about 30 μm. In other embodiments the d₁₀ ranges from about 10 μm to about 30 μm, or from about 20 μm to about 30 μm. In some embodiments the d₅₀ of the composite filter aid ranges from about 25 μm to about 70 μm. In other embodiments the d₅₀ ranges from about 50 μm to about 70 μm, or from about 60 μm to about 70 μm. In some embodiments the d₉₀ of the composite filter aid ranges from about 80 μm to about 120 μm. In some embodiments the d₉₀ ranges from about 90 μm to about 120 μm. In other embodiments the d₉₀ ranges from about 100 μm to about 120 μm, or from about 110 μm to about 120 μm.

In some embodiments the structured composite material may have an aspect ratio in the range of from about 1 to about 50, such as for example from about 1 to about 25, or from about 1.5 to about 20, or from about 2 to about 10.

Composite filter aids disclosed herein may have a measurable wet density, which as used herein refers to measurement of centrifuged wet density. According to one exemplary method, to measure wet density, a composite filer aid sample of known weight from about 1.00 to about 2.00 g is placed in a calibrated 15 ml centrifuge tube to which deionized water is added to make up a volume of approximately 10 ml. The mixture is shaken thoroughly until all of the sample is wetted, and no powder remains. Additional deionized water is added around the top of the centrifuge tube to rinse down any mixture adhering to the side of the tube from shaking. The tube is centrifuged for 5 minutes at 2500 rpm on an IEC Centra® MP-4R centrifuge, equipped with a Model 221 swinging bucket rotor (Intentional Equipment Company; Needham Heights, Mass., USA). Following centrifugation, the tube is carefully removed without disturbing the solids, and the level (i.e., volume) of the settled matter is measured in cm³. The centrifuged wet density of powder is readily calculated by dividing the sample weight by the measured volume.

In some embodiments the wet density of the composite filter aid ranges from about 9 lbs/ft³ to about 22 lbs/ft³. In other embodiments the wet density ranges from about 10 lbs/ft³ to about 16 lbs/ft³.

In some embodiments the composition of the structured composite material is selected such that a d₅₀ of structured composite material is greater than a d₅₀ of the mineral, and a wet density of the structured composite material is less than a wet density of the mineral. In some embodiments the composition of the structured composite material is selected such that a ratio of a cation exchange capacity of the composite filter aid to a cation exchange capacity of the protein-absorbing binder ranges from about 0.95:1.05 to about 1.05:0.95. In other embodiments the composition of the structured composite material is selected such that the composite filter aid has: a permeability ranging from about 0.01 darcy to about 50 darcys; a wet density ranging from about 12 lb/ft³ to about 22 lb/ft³; a d₅₀ ranging from about 20 microns to about 70 microns; a pore volume ranging from about 2.0 mL/g to about 6.0 mL/g; a median pore size ranging from about 1.0 microns to about 10.0 microns; and a BET surface area ranging from about 3.0 m²/g to about 70.0 m²/g.

One aspect of the composite filter aids of the presence disclosure relates to the ability to maintain low crystalline silica levels while exhibiting high levels of permeability that cannot be attained using conventional filter aids based on diatomaceous earth materials. Forms of crystalline silica include, but are not limited to, quartz, cristobalite, and tridymite. In some embodiments the composite filter aid has a lower content of at least one crystalline silica than a filter aid not formed from a structured composite material as disclosed herein.

Composite filter aids disclosed herein may have a surprisingly low cristobalite content for the level of permeability exhibited by the composite filter aids. Cristobalite content may be measured by any appropriate measurement technique now known to the skilled artisan or hereafter discovered. In one exemplary method, cristobalite content is measured by x-ray diffraction. Cristobalite content may be measured, for example, by the quantitative X-ray diffraction method outlined in H. P. Klug and L. E. Alexander, X-Ray Diffraction Procedures for Polycrystalline and Amorphous Materials 531-563 (2nd ed. 1972). According to one example of that method, a sample is milled in a mortar and pestle to a fine powder, then back-loaded into a sample holder. The sample and its holder are placed into the beam path of an X-ray diffraction system and exposed to collimated X-rays using an accelerating voltage of 40 kV and a current of 20 mA focused on a copper target. Diffraction data are acquired by step-scanning over the angular region representing the interplanar spacing within the crystalline lattice structure of cristobalite, yielding the greatest diffracted intensity. That region ranges from 21 to 23 2θ (2-theta), with data collected in 0.05 2θ steps, counted for 20 seconds per step. The net integrated peak intensity is compared with those of standards of cristobalite prepared by the standard additions method in silica to determine the weight percent of the cristobalite phase in a sample.

In some embodiments the cristobalite content of the composite filter aid is less than about 20% by weight. In other embodiments the cristobalite content is less than about 10% by weight, or is less than about 6% by weight, or is less than about 1% by weight. In some embodiments the composite filter aid has a lower cristobalite content than a filter aid not containing the structured composite materials as disclosed herein.

Composite filter aids disclosed herein may have a low quartz content. Quartz content may be measured by any appropriate measurement technique now known to the skilled artisan or hereafter discovered. In one exemplary method, quartz content is measured by x-ray diffraction. For example, quartz content may be measured by the same x-ray diffraction method described above for cristobalite content, except that the 2θ region ranges from 26.0 to 27.5 degrees. In some embodiments the quartz content of the composite filter aid is less than about 0.5% by weight. In other embodiments the quartz content is less than about 0.25% by weight, or less than about 0.1% by weight, or is about 0% by weight.

Some embodiments of this disclosure also relate to structured composite materials formed in a manner such that the mass ratio of the protein-adsorbing binder to the mineral is modulated in order to control the properties of the structured composite materials. For example, some structured composite materials contain an mineral bound to a phyllosilicate, wherein the mass ratio of the phyllosilicate to the mineral is set such that: (i) a permeability of the structured composite material is greater than permeabilities of the mineral and the phyllosilicate; (ii) a d₅₀ of the structured composite material is greater than a d₅₀ of the mineral; (iii) a wet density of the structured composite material is less than a wet density of the mineral; and (iv) the structured composite material has a crystalline silica level of less than about 1% by weight.

### Processes for Making Composite Filter Aids

Some embodiments relate to processes for making composite filter aids containing a structured composite material as disclosed above. For example, some methods involve blending a mineral with a protein-adsorbing binder and optionally with another binder to obtain a structured composite material that can be used directly as a composite filter aid or can be blended with other additives to form a composite filter aid.

In some embodiments the mineral is co-agglomerated with the protein-adsorbing binder to prepare the structured composite material. Co-agglomeration may occur using agglomeration processes now known to the skilled artisan or hereafter discovered. For example, in some embodiments, co-agglomeration includes preparing at least one aqueous mixture of the protein-adsorbing binder, and contacting the binder solution with a composition containing the mineral. One or more agglomerations may be performed, for example, using multiple binders, multiple minerals, or any combination thereof.

In some embodiments the process for making the composite filter aid involves the steps of contacting a binder with a liquid to obtain a binder mixture, mixing the binder mixture with a composition comprising the mineral to obtain a mixed composite, and drying the mixed composite, to obtain the structured composite material. The process may include a step of, after the drying, classifying a dried composite, to obtain the structured composite material. The process may include a step of, after the drying, calcining a dried composite, to obtain the structured composite material. In other embodiments the process may include the steps of, after the drying, calcining a dried composite to obtain a calcined composite and then classifying a calcined composite, to obtain the structured composite material.

The drying and calcining steps described above may occur under temperature-controlled conditions. For example, the drying may occur at a temperature of less than or equal to 200° C. In other embodiments the process may include a step of, after the drying, calcining a dried composite at a temperature ranging from about 600° C. to about 900° C., to obtain the structured composite material.

In some embodiments the binder used to prepare the binder mixture is the protein-adsorbing binder, whereas in other embodiments an additional binder is used to prepare the binder mixture and the composite mixed with the binder mixture contains both of the mineral and the protein-adsorbing binder.

In the above process the “liquid” used to prepare the binder mixture may be a liquid substance capable of dispersing or solubilizing the binder used to prepare the binder mixture. The liquid may contain a single substance or a mixture of substances. For example, the liquid may contain a single solvent or a mixture of solvents. In some embodiments the liquid may be an aqueous dispersing medium. An aqueous dispersing medium may include water, or a mixture of water and at least one organic solvent. The liquid may also contain water, at least one organic solvent and at least one dispersing agent. In some embodiments the liquid is a homogeneous dispersing medium, while in other embodiments the dispersing medium is a heterogeneous dispersing medium. In some embodiments the liquid may be a multi-phase dispersing medium.

In some embodiments the mixing of the binder mixture with the composition occurs with sufficient agitation to uniformly distribute the binder among the agglomeration points of contact of the mixed composite without damaging the structure of the mineral. In some embodiments the mixing includes low-shear mixing.

In some embodiments mixing occurs for about one hour. In other embodiments mixing occurs for less than about one hour, or for about 30 minutes, or for about 20 minutes, or for about 10 minutes. In some embodiments mixing occurs at about room temperature (i.e., from about 20° C. to about 23° C.). In other embodiments mixing occurs at a temperature ranging from about 20° C. to about 50° C., or from about 30° C. to about 45° C., or from about 35° C. to about 40° C.

According to some embodiments the mixing includes spraying the composition comprising the mineral with at least one binder mixture. In some embodiments the spraying is intermittent. In other embodiments the spraying is continuous. In further embodiments spraying includes mixing the composition while spraying with at least one binder mixture, for example, to expose different agglomeration points of contacts to the spray. Such mixing may be intermittent, continuous, or a combination thereof.

In some embodiments at least one binder is present in the binder mixture in an amount less than about 40% by weight, relative to the weight of the binder mixture. In some embodiments the at least one binder is present in the binder mixture in an amount ranging from about 1% to about 10% by weight, or from about 1% to about 5% by weight.

In some embodiments the mineral, the protein-adsorbing binder, the optional additional binder and/or the structured composite material may be subjected to at least one classification step. For example, before and/or after at least one heat treatment, the mineral may, in some embodiments, be subjected to at least one classification step. In some embodiments the particle size of the mineral and/or the protein-adsorbing binder may be adjusted to a suitable or desired size using any one of several techniques well known in the art. In some embodiments the mineral and/or the protein-adsorbing binder may be subjected to at least one mechanical separation to adjust the powder size distribution. Appropriate mechanical separation techniques are well known to the skilled artisan and include, but are not limited to, milling, grinding, screening, extrusion, triboelectric separation, liquid classification, aging, and air classification.

In some embodiments the mineral, the protein-adsorbing binder, the optional additional binder and/or the structured composite material may be subjected to at least one heat treatment. Appropriate heat treatment processes are well-known to the skilled artisan and include those now known or that may hereinafter be discovered. In some embodiments the at least one heat treatment decreases the amount of organics and/or volatiles in the heat-treated mineral. In some embodiments the at least one heat treatment includes at least one calcination. In some embodiments the at least one heat treatment includes at least one flux calcination. In some embodiments the at least one heat treatment includes at least one roasting.

Calcination may be conducted according to any appropriate process now known to the skilled artisan or hereafter discovered. In some embodiments calcination is conducted at temperatures below the melting point of the mineral. In some embodiments calcination is conducted at a temperature ranging from about 600° C. to about 1100° C. In other embodiments the calcination temperature ranges from about 600° C. to about 700° C., or from about 700° C. to about 800° C., or from about 800° C. to about 900° C. Heat treatment at a lower temperature may result in an energy savings over other processes for the preparation of the mineral.

Flux calcination involves conducting at least one calcination in the presence of at least one fluxing agent. Flux calcination may be conducted according to any appropriate process now known to the skilled artisan or hereafter discovered. In some embodiments the at least one fluxing agent is any material now known to the skilled artisan or hereafter discovered that may act as a fluxing agent. In some embodiments the at least one fluxing agent is a salt including at least one alkali metal. In some embodiments the at least one fluxing agent is chosen from the group consisting of carbonate, silicate, chloride, and hydroxide salts. In other embodiments the at least one fluxing agent is chosen from the group consisting of sodium, potassium, rubidium, and cesium salts. In still further embodiments the at least one fluxing agent is chosen from the group consisting of sodium, potassium, rubidium, and cesium carbonate salts.

Roasting may be conducted according to any appropriate process now known to the skilled artisan or hereafter discovered. In some embodiments roasting is a calcination process conducted at a generally lower temperature that helps to avoid formation of crystalline silica in, for example, the diatomaceous earth and/or natural glass. In some embodiments roasting is conducted at a temperature ranging from about 450° C. to about 900° C.

### Uses of Composite Filter Aids

Composite filter aids disclosed herein may be used in any of a variety of processes, applications, and materials. For example, the composite filter aids of the present disclosure may be used as a filter aid medium alone or in combination with at least one additional filter aid medium. Examples of suitable additional filter aid media include, but are not limited to, natural or synthetic silicate or aluminosilicate materials, unimproved diatomaceous earth, saltwater diatomaceous earth, expanded perlite, pumicite, natural glass, cellulose, activated charcoal, feldspars, nepheline syenite, sepiolite, zeolite, mica, talk, clay, kaolin, smectite, wollastonite, organic polymers and combinations thereof.

The at least one additional filter medium may be present in any appropriate amount. For example, the composite filter aid may contain at least one additional filter medium in a proportion of from about 0.01 to about 100 parts of at least one additional filter medium per part of the composite filter aid. In other embodiments the at least one additional filter medium is present from about 0.1 to about 10 parts, or from about 0.5 to 5 parts.

The composite filter aid may be formed into sheets, pads, cartridges, or other monolithic or aggregate media capable of being used as supports or substrates in a filter process. Considerations in the manufacture of filter aid compositions may include a variety of parameters, including but not limited to total soluble metal content of the composition, median soluble metal content of the composition, particle size distribution, pore size, cost, and availability.

Composite filter aids and structured composite materials of the present disclosure may be used in a variety of processes and compositions. In some embodiments the composite filter aid is applied to a filter septum to protect it and/or to improve clarity of the liquid to be filtered in a filtration process. In some embodiments the composite filter aid is added directly to a beverage to be filtered to increase flow rate and/or extend the filtration cycle. In some embodiments the composite filter aid composition is used as pre-coating, in body feeding, or a combination of both pre-coating and body feeding, in a filtration process.

Embodiments of the present disclosure include a filtering method involving contacting a fluid with the composite filter aid. In some embodiments the contacting step may involve passing at least one fluid through at least one filter membrane containing the composite filter aid. In other embodiments the contacting step may involve pre-coating at least one filter with the composite filter aid, and then passing at least one fluid through the at least one filter. In still other embodiments the contacting step may involve adding the composite filter aid to at least one fluid, and then passing the at least one fluid through at least one filter. Other embodiments involve pre-coating at least one filter with the composite filter aid, and then passing at least one fluid through the at least one filter, wherein the at least one fluid contains the composite filter aid.

Composite filter disclosed herein may also be employed to filter various types of liquids. The skilled artisan is readily aware of liquids that may be desirably filtered with a process including the filter aids including at least composite material disclosed herein. In some embodiments the liquid is a beverage. Exemplary beverages include, but are not limited to, vegetable-based juices, fruit juices, distilled spirits, and malt-based liquids. Exemplary malt-based liquids include, but are not limited to, beer and wine. In some embodiments the liquid is one that tends to form haze upon chilling. In some embodiments the liquid is a beverage that tends to form haze upon chilling. In some embodiments the liquid is a beer. In some embodiments the liquid is an oil. In some embodiments the liquid is an edible oil. In some embodiments the liquid is a fuel oil. In some embodiments the liquid is water, including but not limited to waste water. In some embodiments the liquid is blood. In some embodiments the liquid is a sake. In some embodiments the liquid is a sweetener, such as, for example, corn syrup or molasses.

Some embodiments involve the filtering method described above in which the fluid is a liquid selected from a beverage, an edible oil and a fuel oil. For example, in some embodiments the fluid is a wine.

Embodiments of the present disclosure also include a stabilized beverage obtained by performing the filtering method described above on a beverage such as a wine. One embodiment, for example, involves contacting a beverage with the composite filter aid in order to obtain a stabilized beverage, wherein the beverage is a wine, the mineral is a calcined diatomaceous earth, and the protein-absorbing binder is a calcium bentonite.

The composite filter aids and structured composite materials disclosed herein may also be used in applications other than filtration. In some embodiments composite materials disclosed herein may be used in filler applications, such as, for example, fillers in construction or building materials. In some embodiments the composite materials disclosed herein may be used to alter the appearance and/or properties of paints, enamels, lacquers, or related coatings and finishes. In some embodiments the composite materials disclosed herein may be used in paper formulations and/or paper processing applications. In some embodiments the composite materials disclosed herein may be used to provide anti-block and/or reinforcing properties to polymers. In some embodiments the composite materials disclosed herein may be used as or in abrasives. In some embodiments the composite materials disclosed herein may be used for buffing or in buffing compositions. In some embodiments the composite materials disclosed herein may be used for polishing or in polishing compositions. In some embodiments the composite materials disclosed herein may be used in the processing and/or preparation of catalysts. In some embodiments the composite materials disclosed herein may be used as chromatographic supports or other support media. In some embodiments the composite materials disclosed herein may be blended, mixed, or otherwise combined with other ingredients to make monolithic or aggregate media useful in a variety of applications, including but not limited to supports (e.g., for microbe immobilization) and substrates (e.g., for enzyme immobilization).

### Embodiments

Embodiment [1] of the present disclosure relates to a composite filter aid, comprising a structured composite material formed by agglomerating an mineral with a protein-adsorbing binder, wherein: the structured composite material comprises a particle of the protein-adsorbing binder bonded to a plurality of particles of the mineral; a permeability of the structured composite material is greater than a permeability of the mineral; and the permeability of the structured composite material is greater than a permeability of the protein-adsorbing binder.

Embodiment [2] of the present disclosure relates to the composite filter aid of Embodiment [1], wherein: the structured composite material comprises a core comprising the particle of the protein-adsorbing binder; and the core is at least partially covered by a shell comprising the plurality of particles of the mineral.

Embodiment [3] of the present disclosure relates to the composite filter aid of Embodiments [1]-[2], wherein the mineral is at least one selected from the group consisting of a biogenic mineral and a natural glass.

Embodiment [4] of the present disclosure relates to the composite filter aid of Embodiments [1]-[3], wherein the mineral is a biogenic mineral selected from the group consisting of a mineral carbonate, a mineral phosphate, a mineral halide, a mineral oxalate, a mineral sulfate, a mineral silicate, an iron oxide, a manganese oxide, an iron sulfide, and mixtures thereof.

Embodiment [5] of the present disclosure relates to the composite filter aid of Embodiments [1]-[4], wherein the mineral is a biogenic mineral is selected from the group consisting of a natural diatomaceous earth, a modified diatomaceous earth, and mixtures thereof.

Embodiment [6] of the present disclosure relates to the composite filter aid of Embodiments [1]-[5], wherein the mineral is a nature glass selected from the group consisting of a perlite, a volcanic ash, a pumice, a shirasu, an obsidian, a pitchstone, a rice hull ash, and mixtures thereof.

Embodiment [7] of the present disclosure relates to the composite filter aid of Embodiments [1]-[6], wherein the protein-adsorbing binder is a phyllosilicate mineral selected from the group consisting of a serpentine mineral, a clay mineral, a mica mineral and a chlorite mineral.

Embodiment [8] of the present disclosure relates to the composite filter aid of Embodiments [1]-[7], wherein the protein-adsorbing binder is a phyllosilicate mineral selected from the group consisting of an antigorite (Mg₃Si₂O₅(OH)₄), a chrysotile (Mg₃Si₂O₅(OH)₄), a lizardite (Mg₃Si₂O₅(OH)₄), a halloysite (Al₂Si₂O₅(OH)₄), an kaolinite (Al₂Si₂O₅(OH)₄), an illite ((K,H₃O) (Al,Mg, Fe)₂ (Si,A)₄O₁₀[(OH)₂.(H₂O)]), a montmorillonite ((Na,Ca)_{0.33} (Al,Mg)₂Si₄O₁₀(OH)₂.nH₂O), a vermiculite ((MgFe,Al)₃(Al,Si)₄O₁₀ (OH)₂.4H₂O), a talc (Mg₃Si₄O₁₀(OH)₂), a sepiolite (Mg₄Si₆O₁₅(OH)₂.6H₂O), a palygorskite ((Mg,Al)₂Si₄O₁₀ (OH).4(H₂O)), an attapulgite ((Mg,Al)₂Si₄O₁₀ (OH).4(H₂O)), a pyrophyllite (Al₂Si₄O₁₀(OH)₂), a biotite (K(Mg,Fe)₃(AlSi₃)O₁₀(OH)₂), a muscovite (KAl₂(AlSi₃) O₁₀(OH)₂), a phlogopite (KMg₃ (AlSi₃)O₁₀(OH)₂), a lepidolite (K(Li,Al)₂₋₃(AlSi₃) O₁₀(OH)₂), a margarite (CaAl₂ (Al₂Si₂)O₁₀(OH)₂), a glauconite ((K,Na) (Al,Mg,Fe)₂(Si,Al)₄O₁₀ (OH)₂), a chlorite ((Mg,Fe)₃(Si,Al)₄O₁₀(OH)₂. (Mg,Fe)₃ (OH)₆), and mixtures thereof.

Embodiment [9] of the present disclosure relates to the composite filter aid of Embodiments [1]-[8], wherein the phyllosilicate is selected from the group consisting of a sodium bentonite, a calcium bentonite, a potassium bentonite, and mixtures thereof.

Embodiment [10] of the present disclosure relates to the composite filter aid of Embodiments [1]-[9], wherein the structured composite material is formed by agglomerating the mineral with the protein-adsorbing binder in the presence of an additional binder that is different from the mineral and the protein-adsorbing binder.

Embodiment [11] of the present disclosure relates to the composite filter aid of Embodiments [1]-[10], wherein: the structured composite material is formed by agglomerating the mineral with the protein-adsorbing binder in the presence of an additional binder that is different from the mineral and the protein-adsorbing binder; and the additional binder is at least one selected from the group consisting of an inorganic binder and an organic binder.

Embodiment [12] of the present disclosure relates to the composite filter aid of Embodiments [1]-[11], wherein: the structured composite material is formed by agglomerating the mineral with the protein-adsorbing binder in the presence of an additional binder that is different from the mineral and the protein-adsorbing binder; and the additional binder is at least one inorganic binder selected from the group consisting of a silicate, a cement and a clay.

Embodiment [13] of the present disclosure relates to the composite filter aid of Embodiments [1]-[12], wherein: the structured composite material is formed by agglomerating the mineral with the protein-adsorbing binder in the presence of an additional binder that is different from the mineral and the protein-adsorbing binder; and the additional binder is at least one inorganic binder selected from the group consisting of sodium silicate and potassium silicate.

Embodiment [14] of the present disclosure relates to the composite filter aid of Embodiments [1]-[13], wherein: the structured composite material is formed by agglomerating the mineral with the protein-adsorbing binder in the presence of an additional binder that is different from the mineral and the protein-adsorbing binder; and the additional binder is at least one organic binder selected from the group consisting of a cellulose, a polyethylene glycol (PEG), a polyvinyl alcohol (PVA), a polyvinylpyrrolidone (PVP), a starch, a silicone, a Candalilla wax, a polyacrylate, a polydiallyldimethylammonium chloride polymer, a dextrin, a lignosulfonate, a sodium alginate, a magnesium stearate, and mixtures thereof.

Embodiment [15] of the present disclosure relates to the composite filter aid of Embodiments [1]-[14], wherein: the structured composite material is formed by agglomerating the mineral with the protein-adsorbing binder in the presence of an additional binder that is different from the mineral and the protein-adsorbing binder; and the additional binder is at least one organic binder selected from the group consisting of a linear silicon polymer, a ring-shaped silicone polymer and a resin silicone polymer.

Embodiment [16] of the present disclosure relates to the composite filter aid of Embodiments [1]-[15], wherein a mass ratio of the protein-adsorbing binder to the mineral ranges from about 0.01:99.99 to about 50:50.

Embodiment [17] of the present disclosure relates to the composite filter aid of Embodiments [1]-[16], having a crystalline silica level of less than about 1% by weight.

Embodiment [18] of the present disclosure relates to the composite filter aid of Embodiments [1]-[17], wherein: a d₅₀ of structured composite material is greater than a d₅₀ of the mineral; and a wet density of the structured composite material is less than a wet density of the mineral.

Embodiment [19] of the present disclosure relates to the composite filter aid of Embodiments [1]-[18], wherein a ratio of a cation exchange capacity of the composite filter aid to a cation exchange capacity of the protein-absorbing binder ranges from about 0.95:1.05 to about 1.05:0.95.

Embodiment [20] of the present disclosure relates to the composite filter aid of Embodiments [1]-[19], wherein the composite filter aid has: a permeability ranging from about 0.01 darcy to about 50 darcys; a wet density ranging from about 12 lb/ft³ to about 22 lb/ft³; a d₅₀ ranging from about 20 microns to about 70 microns; a pore volume ranging from about 2.0 mL/g to about 6.0 mL/g; a median pore size ranging from about 1.0 microns to about 10.0 microns; and a BET surface area ranging from about 3.0 m²/g to about 70.0 m²/g.

Embodiment [21] of the present disclosure relates to a structured composite material, comprising an mineral bound to a phyllosilicate, wherein a mass ratio of the phyllosilicate to the mineral is set such that: (i) a permeability of the structured composite material is greater than permeabilities of the mineral and the phyllosilicate; (ii) a d₅₀ of the structured composite material is greater than a d₅₀ of the mineral; (iii) a wet density of the structured composite material is less than a wet density of the mineral; and (iv) the structured composite material has a crystalline silica level of less than about 1% by weight.

Embodiment [22] of the present disclosure relates to the structured composite material of Embodiment [21], wherein the mineral is at least one selected from the group consisting of a biogenic mineral and a natural glass.

Embodiment [23] of the present disclosure relates to the structured composite material of Embodiments [21]-[22], wherein the mineral is a biogenic mineral is selected from the group consisting of a natural diatomaceous earth, a modified diatomaceous earth, and mixtures thereof.

Embodiment [24] of the present disclosure relates to the structured composite material of Embodiments [21]-[23], wherein the mineral is a nature glass selected from the group consisting of a perlite, a volcanic ash, a pumice, a shirasu, an obsidian, a pitchstone, a rice hull ash, and mixtures thereof.

Embodiment [25] of the present disclosure relates to the structured composite material of Embodiments [21]-[24], wherein the phyllosilicate is selected from the group consisting of a sodium bentonite, a calcium bentonite, a potassium bentonite, and mixtures thereof.

Embodiment [26] of the present disclosure relates to the structured composite material of Embodiments [21]-[25], wherein: the structured composite material is formed by agglomerating the mineral with the phyllosilicate in the presence of a binder that is different from the mineral and the phyllosilicate; and the binder is at least one selected from the group consisting of an inorganic binder and an organic binder.

Embodiment [27] of the present disclosure relates to the structured composite material of Embodiments [21]-[26], wherein the mass ratio ranges from about 0.01:99.99 to about 50:50.

Embodiment [28] of the present disclosure relates to a process for making the composite filter aid of Embodiment [1], the process comprising: contacting a binder with a liquid to obtain a binder mixture; mixing the binder mixture with a composition comprising the mineral to obtain a mixed composite; and drying the mixed composite, to obtain the structured composite material.

Embodiment [29] of the present disclosure relates to the process of Embodiment [28], further comprising, after the drying, classifying a dried composite, to obtain the structured composite material.

Embodiment [30] of the present disclosure relates to the process of Embodiments [28]-[28], further comprising, after the drying, calcining a dried composite, to obtain the structured composite material.

Embodiment [31] of the present disclosure relates to the process of Embodiments [28]-[30], further comprising: after the drying, calcining a dried composite to obtain a calcined composite; and classifying a calcined composite, to obtain the structured composite material.

Embodiment [32] of the present disclosure relates to the process of Embodiments [28]-[31], wherein the drying occurs at a temperature of less than or equal to 200° C.

Embodiment [33] of the present disclosure relates to the process of Embodiments [28]-[32], further comprising, after the drying, calcining a dried composite at a temperature ranging from about 600° C. to about 900° C., to obtain the structured composite material.

Embodiment [34] of the present disclosure relates to the process of Embodiments [28]-[33], wherein the binder comprises the protein-absorbing binder.

Embodiment [35] of the present disclosure relates to the process of Embodiments [28]-[34], wherein: the binder comprises an additional binder that is different from the mineral and the protein-adsorbing binder; and the composition comprises the mineral and the protein-adsorbing binder.

Embodiment [36] of the present disclosure relates to a filtering method, comprising contacting a fluid with the composite filter aid of Embodiment [1].

Embodiment [37] of the present disclosure relates to the method of Embodiment [36], comprising passing at least one fluid through at least one filter membrane containing the composite filter aid.

Embodiment [38] of the present disclosure relates to the method of Embodiments [36]-[37], comprising: pre-coating at least one filter with the composite filter aid; and then passing at least one fluid through the at least one filter.

Embodiment [39] of the present disclosure relates to the method of Embodiments [36]-[38], comprising: adding the composite filter aid to at least one fluid; and then passing the at least one fluid through at least one filter.

Embodiment [40] of the present disclosure relates to the method of Embodiments [36]-[39] comprising: pre-coating at least one filter with the composite filter aid; and then passing at least one fluid through the at least one filter, wherein the at least one fluid contains the composite filter aid.

Embodiment [41] of the present disclosure relates to the method of Embodiments [36]-[40], wherein the fluid is a liquid selected from the group consisting of a beverage, an edible oil and a fuel oil.

Embodiment [42] of the present disclosure relates to the method of Embodiments [36]-[41], wherein the fluid is a wine.

Embodiment [43] of the present disclosure relates to a stabilized beverage obtained by performing the filtering method of Embodiment [36] on a beverage.

Embodiment [44] of the present disclosure relates to the stabilized beverage of Embodiment [43], wherein the beverage is a wine.

Embodiment [45] of the present disclosure relates to the stabilized beverage of Embodiments [43]-[44], wherein: the beverage is a wine; the material is a calcined diatomaceous earth; and the protein-absorbing binder is a calcium bentonite.

Embodiment [46] of the present disclosure relates to the composite filter aid of Embodiments [1]-[20], wherein the structured composite material comprises integrated composited particles of the protein-adsorbing binder bonded to the mineral.

### EXAMPLES

The following examples are provided for illustration purposes only and in no way limit the scope of the present disclosure. Embodiments of the present disclosure may employ the use of different or additional components compared to the materials illustrated below, such as other structured composite materials and filter aids based on different minerals, protein-adsorbing binders and other binders, as well as additional components and additives. Embodiments of the present disclosure may also employ the use of different process conditions than the conditions illustrated below for the preparation of structured composite materials and filtering aids. Embodiments of the present disclosure may also employ different filtering and purification methods than the methods illustrated below.

### Study Overview

In the examples illustrated below, the physical characteristics and filtering characteristics of structured composite materials and composite filter aids were controlled by altering the identity and properties of materials used to prepare the structured composite materials, and also by altering the process conditions used to prepare the structured composite materials. Comparison studies below illustrate that characteristics such as the permeability, cation exchange capacity, crystalline silica level, protein adsorption and the stabilization capability of structured composite materials can be controlled to produce filter aids exhibiting superior characteristics compared to common filtering aids such as natural and modified diatomaceous earths.

### Materials

Commercial calcined diatomite filter aid Standard Super-Cel® obtained from Imerys Filtration Minerals was used as a mineral and also as a comparison filter aid. Commercial flux calcined diatomite filter aid Hyflo Super-Cel® obtained from Imerys Filtration Minerals was used as a comparison filter aid. Commercial calcium bentonite products obtained from Bavaria and Morocco were used as protein-adsorption binders. Magnesium aluminum silicate bentonite obtained from BYK Additives and Instruments was used as a protein-adsorption binder. Sodium metasilicate (Na₂SiO₃) purchased from Sigma-Aldrich was used as an additional binder. Deionized water was used as a liquid in the preparation of structured composite materials. Concentrated sulfuric acid (H₂SO₄) purchased from Sigma-Aldrich was used as an acid in the preparation of acid-activated bentonite. Ferrous sulfate (FeSO₄.xH₂O) purchased from Sigma-Aldrich was used as an antioxidant in the preparation of acid-activated bentonite via conventional acid activation methods familiar to one of ordinary skill in the art.

### The Effect of Bentonite Source and Proportion on the Permeability and Wet Density of Composite Filter Aids

3 g (Examples 1 and Example 7) or 5 g (all other Examples) of sodium silicate was dispersed in 20 g of DI water, and then resulting dispersion is slowly added to a mixture of 100 g of diatomaceous earth (DE) (Standard Super-Cel®) and a calcium bentonite in a Hobart food mixer. Bavaria bentonite was used to make Examples 1-6 and Morocco bentonite was used to make Examples 7-10. The DE to bentonite mixing ratios are shown in Table 1 below. After mixing with a sodium silicate solution for 15 minutes, the resulting mixture was dried in a 150° C. oven overnight. The dried material was then brushed through a 30 mesh (0.6 mm opening) screen. As shown in Table 1 below, the DE and bentonite composite filter aids have permeability ranged from 0.05 to 0.57 Darcy.

As illustrated in Table 1 below, the source and proportion of bentonite used to prepare composite filter aids profoundly affects their permeabilities and wet densities. In Examples 1-6 using Bavarian bentonite, the mass ratio of the bentonite to the diatomaceous earth is increased from 5:95 to 80:70, leading to a significant reduction in the permeability of the composite filter aids from 0.57 darcy to 0.05 darcy, and leading to an increase in the wet density of the composite filter aids from 16.9 lb/f³ to 20.8 lb/f³. A similar trend is also observed in Examples 7-10 using Moroccan bentonite, as the mass ratio of the bentonite to the diatomaceous earth increased from 5:95 to 20:80 the permeability of the composite filter aids decreased from 0.57 darcy to 0.02 darcy, and the wet density increases from 19.9 lb/f³ to 20.8 lb/f³. Comparing the permeabilities for the composite filter aids of Examples 1-6 versus the composite filter aids of Examples 7-10 shows that increasing the proportion of Moroccan bentonite leads to a larger reduction in permeability, relative to increasing the proportion of Bavarian bentonite.

TABLE 1
Composition and Filtration Properties of Composite Filter Aids

| | | BE ^{b)} | Sodium | | |
|---|---|---|---|---|---|
| | DE ^{a)} | (g) | Silicate | Permeability | Wet Density |
| Sample ID | (g) | (source) | (g) | (Darcy) | (lb/cf) |
| Example 1 | 95 | 5 | 5 | 0.57 | 16.9 |
| | | (Bavarian) | | | |
| Example 2 | 90 | 10 | 3 | 0.32 | 19.5 |
| | | (Bavarian) | | | |
| Example 3 | 85 | 15 | 3 | 0.21 | 19.2 |
| | | (Bavarian) | | | |
| Example 4 | 80 | 20 | 3 | 0.15 | 19.2 |
| | | (Bavarian) | | | |
| Example 5 | 75 | 25 | 3 | 0.10 | 20.5 |
| | | (Bavarian) | | | |
| Example 6 | 70 | 30 | 3 | 0.05 | 20.8 |
| | | (Bavarian) | | | |
| Example 7 | 95 | 5 | 5 | 0.57 | 16.9 |
| | | (Moroccan) | | | |
| Example 8 | 90 | 10 | 3 | 0.30 | 18.4 |
| | | (Moroccan) | | | |
| Example 9 | 85 | 15 | 3 | 0.08 | 20.1 |
| | | (Moroccan) | | | |
| Example 10 | 80 | 20 | 3 | 0.02 | 20.8 |
| | | (Moroccan) | | | |

^{a)} Standard Super-Cel ® Diatomaceous Earth
^{b)} Calcium Bentonite

As illustrated in Table 1 above, relatively high proportions of Bavarian and Moroccan bentonite may be used to prepare composite filter aids having technically-acceptable permeabilities ranging from 0.02 darcy to 0.57 darcy. It was discovered that including an additional binder such as the sodium silicate used in Examples 1-10 enables these relatively high proportions of bentonite. As further illustrated in Table 6 below, omission of the additional binder (e.g., sodium silicate) can lead to a dramatic reduction in the proportion of bentonite necessary to produce composite filter aids having technically-acceptable permeabilities.

### Comparing the Surface Area of the Composite Filter Aid to the Surface Areas of the Mineral and the Protein-Adsorbing Binder

BET surface areas of the composite filter aid of Example 6, the Bavarian bentonite, the Moroccan bentonite, and the diatomaceous earth were measured with a Gemini III 2375 Surface Area Analyzer, using pure nitrogen as the sorbent gas, from Micromeritics Instrument Corporation (Norcross, Ga., USA). The measured BET surface areas are shown in Table 2 below.

TABLE 2
Surface Areas of Composite Filter Aid versus
Conventional Filter Aid and Bentonites

| | | BE ^{b)} | Sodium | |
|---|---|---|---|---|
| | DE ^{a)} | (g) | Silicate | Surface Area |
| Sample ID | (g) | (source) | (g) | (m²/g) |
| Example 6 | 70 | 30 | 3 | 21.2 |
| | | (Bavarian) | | |

| | | |
|---|---|---|
| Calcium | n/a | 71.5 |
| Bentonite | | |
| (Bavarian) | | |
| Calcium | | 37.7 |
| Bentonite | | |
| (Moroccan) | | |
| Standard | | 4.4 |
| Super-Cel ® | | |
| (calcined DE) | | |

^{a)} Standard Super-Cel ® Diatomaceous Earth
^{b)} Calcium Bentonite
n/a not applicable

As shown in Table 2 above, the BET surface area of the composite filter aid of Example 6 is greater than the BET surface of the diatomaceous earth (Standard Super-Cel®) used to prepare Example 6—and is less than the BET surface areas of Moroccan bentonite and the Bavarian bentonite used to prepare Example 6. Thus, the BET surface area of the composite filter aid of Example 6 is significantly higher than the BET surface area of a commercial calcined DE filter aid (Standard Super-Cel®).

### Comparing the Cation Exchange Capacity of the Composite Filter Aid to the Cation Exchange Capacity of the Protein-Adsorbing Binder

Cation Exchange Capacities (CEC) of the composite filter aid of Example 6 and the Bavarian bentonite used to prepare Example 6 were measured by mixing 0.3 g of filter aid with 50 mL of mixed solution of 0.01 M AgNO₃ and 0.1 M Thiourea solution. After mixing for two hours, the solution was centrifuged at 4000 rpm for 10 min. The supernatant liquid was then filtered with Whatman #42 filter paper into a flask containing 10 mL of 0.5 N HNO₃. The remaining precipitate was washed with 40 mL of DI water and centrifuged at 4000 rpm for 10 min. The supernatant was filtered, and the washing process above was repeated 4 times (total of 5 centrifugations). Enough 0.5 HNO₃ was added to bring the volume of the solution to 250 mL. After stirring the solution, 1 mL of solution was taken and added to a 50 mL volumetric flask. The flask was then filled with a 0.5 N HNO₃ solution to create a 2% dilution. ICP was used to measure the silver content in the resulting solution. Cation exchange capacities (CEC) in meq/100 g were calculated using the equation: CEC=(2xa−b)×39.416, where a is the measurement of element Ag in the blank reference solution, and b is the measurement of element Ag in the resulting solution. The measured CECs are shown in Table 3 below.

TABLE 3
Cation Exchange Capacity of Composite
Filter Aid versus Bentonite

| | | | | Cation |
|---|---|---|---|---|
| | | BE ^{b)} | Sodium | Exchange |
| | DE ^{a)} | (g) | Silicate | Capacity |
| Sample ID | (g) | (source) | (g) | (meq/100 g) |
| Example 6 | 70 | 30 | 3 | 92 |
| | | (Bavarian) | | |

| | | |
|---|---|---|
| Calcium | n/a | 91 |
| Bentonite | | |
| (Bavarian) | | |

^{a)} Standard Super-Cel ® Diatomaceous Earth
^{b)} Calcium Bentonite
n/a not applicable

As illustrated in Table 3 above, the composite filter aid of Example 6 exhibits an almost identical cation exchange capacity to that of the Bavarian bentonite used to prepare Example 6. This ability to retain the cation exchange capacity of the original bentonite can be advantageous, especially in embodiments where the composite filter aid is used as an ion exchange agent. In the context of wine fining, for example, use of a composite filter aid formed from a calcium bentonite to purify wine can lead to reduction of sodium content by exchanging sodium ions with calcium ions.

### Comparing the Protein Adsorption Characteristics of Composite Filter Aids Based on Bavarian Bentonite in Contact with a Model Wine Solution

Protein adsorptions for the composite filter aids of Examples 1-6 were measured using a model wine solution of 2 g/L KHTa, 12% ethanol, and 600 mg/L bovine serum albumin at pH of 3.5 [see Blade, W. H.; Boulton, R., “Adsorption of Protein by Bentonite in a Model Wine Solution” Am. J. Enol. Vitic., 1988, 39(3), 193-99]. The respective composite filter aid was added to DI water at 2.4 g/100 mL concentration, and the slurry was hydrated for 24 hrs. 5 mL of slurry was added to 25 mL of model wine solution and mix for 30 minutes. The solution was centrifuged at 2500 rpm for 10 min and filtered with 0.25 μm membrane filter paper. 0.1 mL of sample was mixed with 3.0 mL of room temperature Bradford reagent [see “Bradford Reagent,” Technical Bulletin (Sigma-Aldrich)]. After sitting for 5 minutes, absorbance was measured at 595 nm using spectrophotometer (Shimadzu UV-2600). The measured protein adsorption characteristics for Example 1-6, relative to a blank (non-filtered) sample, are shown in Table 4 below.

As illustrated in Table 4 below, the protein adsorptions of the composite filter aids of Example 1-6 increase as the proportion of the bentonite used to prepare the composite filter aid increases. The composite filter aid of Example 6 exhibits an especially high level of protein adsorption—while at the same time affording a technically-acceptable permeability of 0.05 darcy.

TABLE 4
Protein Adsorptions of Composite Filter Aids

| | | | | | Protein | Protein |
|---|---|---|---|---|---|---|
| | DE^{a)} | BE^{b)} | Sodium | Perm. | Concentration | Adsorption |
| Sample ID | (g) | (g) (source) | Silicate (g) | (Darcy) | (mg/L) | (%) |
| Blank | n/a | | | n/a | 610 | n/a |
| (non-filtered) | | | | | | |
| Example 1 | 95 | 5 | 5 | 0.57 | 448 | 27 |
| | | (Bavarian) | | | | |
| Example 2 | 90 | 10 | 3 | 0.32 | 294 | 52 |
| | | (Bavarian) | | | | |
| Example 3 | 85 | 15 | 3 | 0.21 | 363 | 40 |
| | | (Bavarian) | | | | |
| Example 4 | 80 | 20 | 3 | 0.15 | 254 | 58 |
| | | (Bavarian) | | | | |
| Example 5 | 75 | 25 | 3 | 0.10 | 210 | 66 |
| | | (Bavarian) | | | | |
| Example 6 | 70 | 30 | 3 | 0.05 | 197 | 68 |
| | | (Bavarian) | | | | |

^{a)}Standard Super-Cel ® Diatomaceous Earth
^{b)}Calcium Bentonite
n/a not applicable

### Comparing the Heat Stabilities of an Un-Stabilized Wine Versus Wines Stabilized Using a Composite Filter Aid Based on Bavarian Bentonite

Wine Heat Stability Test A wine was filtered through Whatman #4 filter paper and then filtered through 4 micron filter paper (Whatman #597). The filtered wine was added to 30 mL glass tube (VWR 66011-165) and covered with cap to measure turbidity. After loosening the cap slightly, the glass tube was placed in 80° C. oven for 6 hours. After 6 hours, the tube was removed from oven. The cap was tightened and placed in 20° C. water bath for 30 minutes for cooling. After removing the tube from the water bath, the tube was cleaned with Kimwipes™ and

isopropyl alcohol, and inverted slowly. Turbidity was measure following inversion.

Continuous Wine Fining by Filtration

3 grams of Example 6 was added as body feed to 450 mL of a Muscat wine and stirred for 1 hour at low-to-medium speed using an impeller mixer. 2 grams of Example 6 was added to 150 mL of DI water to precoat the Walton filter at 150 mL/min for 5 minutes. After a pre-coat cake was formed on the filter, a pump was switched to pump the body feed wine solution through the Walton filter at 30 mL/min. The filtrate passed through the pre-coated filter was collected at desired time intervals. The collected filtrate samples were then used for heat stability tests, as described above. Table 5 summarizes the heat stability test data for un-stabilized wine versus wines stabilized using the composite filter aid of Example 6.

As shown in Table 5, the un-treated Muscat wine exhibited significantly higher turbidity (12.5 NTU) even before heating, and the significant increase in turbidity (90.5 Δ NTU) further illustrates the instability of the un-treated Muscat wine under heating at 80° C. By contrast, the Muscat wines treated with the composite filter aid of Example 6 for 5 minutes and 10 minutes exhibited very low turbidities (0.568 NTU and 0.257 NTU) before the heating, and exhibited very low changes in turbidity (−0.35 Δ NTU and 0.045 NTU) under heating at 80° C. The Muscat wine treated with the composite filter aid of Example 6 for 5 minutes exhibited a reduction in turbidity—indicating that the composite filter aid of Example 6 imparts excellent stability of this wine model. These results illustrate that a composite filter aid of the present disclosure can be used as a pre-coat and body feed filtering aid in a continuous filtration to stabilize a wine.

TABLE 5
Heat Stabilities of Un-Stabilized Wine and Wines Stabilized
with a Composite Filter Aid Based on Bavarian Bentonite

| | Pre-Heat | Post-Heat | Heat |
|---|---|---|---|
| | Bath | Bath | Stability |
| Sample ID | (NTU) | (NTU) | (Δ NTU) |
| Muscat Wine | 12.5 | 103 | 90.5 |
| (unfiltered) | | | |
| 5 minutes Filtrate Sample | 0.568 | 0.533 | −0.035 |
| of Muscat Wine | | | |
| (filtered) ^{c)} | | | |
| 10 minutes Filtrate Sample | 0.257 | 0.302 | 0.045 |
| of Muscat Wine | | | |
| (filtered) ^{c)} | | | |

^{c)} Example 6 (70 g DE, 30 g BE, 3 g sodium silicate)

### Effects of Bentonite Proportion, Concentration and Calcination Temperature on the Permeability and Cristobalite Content of Composite Filter Aids

A diatomite crude originating from Mexico (Massive crude) was used as the feed DE material. This feed DE material had a particle size distribution of d₁₀ of 7.31 μm, d₅₀ of 20.44 μm, and d₉₀ of 55.11 μm. 1 to 5 g of magnesium aluminum silicate bentonite (BYK Additives & Instruments) was dispersed in 40 to 75 g of water. The bentonite dispersion was then slowly added to 100 to 400 g of the DE feed material with agitation. After mixing in a Hobart mixer for 20 minutes, the mixture was brushed through a 16-mesh (1.19 mm opening) screen. Oversized particles were broken and forced through the screen by brushing. 50 g of the agglomerated material was calcined at 600-900° C. for 30 minutes in an Inconel crucible. The calcined DE & bentonite composite material was then screened through a 30-mesh (0.6 mm opening) screen by brushing. Table 6 below summarizes the composition and process data for Examples 11-21, as well as the permeabilities, cristobalite contents and quartz contents for Examples 11-21 and reference samples of the crude DE, a Standard Super-Cel® DE and a Hyflo Super-Cel® DE.

As illustrated in Table 6 below, the composite filter aids of Examples 11-21 exhibited comparable permeabilities to the conventional filter aids of crude DE, Standard Super-Cel® (calcined) DE and Hyflo Super-Cel® (flux calcined) DE. However, relative to the calcined DE filter aids of Standard Super-Cel® and Hyflo Super-Cel®, the cristobalite contents of the composite filter aids of Examples 11-21 were much lower due to the low calcination temperature, and in many cases comparable to the cristobalite content of the crude DE. Thus, composite filter aids of the present disclosure may be controlled to contain very low amounts of crystalline silica—such as less than 1% by weight of crystalline silica—thereby avoiding health problems associated with crystalline silica.

TABLE 6
Composition and Filtration Properties of Composite Filter
Aids versus Convention Diatomaceous Earth Filter Aids

| | DE^{d)} | BE^{e)} | Water | Temp. | Permeability | Cristobalite | Quartz |
|---|---|---|---|---|---|---|---|
| Sample ID | (g) | (g) | (g) | (° C.) | (Darcy) | (%) | (%) |
| Crude DE^{d)} | n/a | | | | 0.03 | 0.17 | 0.25 |
| Standard Super-Cel ® | | | | | 0.27 | 17.99 | 0.86 |
| (calcined DE) | | | | | | | |
| Hyflo Super-Cel ® | | | | | 1.35 | 35.89 | 0.04 |
| (fiux calcined DE) | | | | | | | |
| Example 11 | 100 | 1 | 50 | 700 | 0.29 | 0.03 | 0.28 |
| Example 12 | 100 | 1 | 50 | 900 | 0.39 | 0.24 | 0.30 |
| Example 13 | 100 | 1 | 75 | 700 | 0.56 | 0.12 | 0.29 |
| Example 14 | 100 | 1 | 75 | 900 | 0.75 | 0.15 | 0.27 |
| Example 15 | 400 | 4 | 400 | 600 | 1.04 | 0.30 | 0.36 |
| Example 16 | 400 | 4 | 400 | 700 | 1.22 | — | — |
| Example 17 | 400 | 4 | 400 | 800 | 2.11 | — | — |
| Example 18 | 100 | 3 | 50 | 700 | 0.24 | 0.15 | 0.31 |
| Example 19 | 100 | 3 | 50 | 900 | 0.35 | 0.29 | 0.35 |
| Example 20 | 100 | 5 | 50 | 700 | 0.23 | 0.18 | 0.29 |
| Example 21 | 100 | 5 | 50 | 900 | 0.34 | 0.39 | 0.23 |

^{d)}Crude diatomaceous earth originating from Mexico (Massive crude DE)
^{e)}Magnesium Aluminum Silicate Bentonite
n/a not applicable
— not measured

Consistent with the study in Table 1 above, the permeabilities of the composite filter aids in Table 6 above were indirectly related to the proportion of the bentonite relative to the amount of the diatomaceous earth used to prepare the composite filter aids. Comparing the results for Examples 11 and 12 versus the results for Examples 18 and 19 in Table 6 shows that increasing the mass ratio of the bentonite from 1 mass % to 3 mass % resulted in a corresponding decrease in the permeability of composite filter aids. Further increasing the proportion of the bentonite to 5 mass % in Examples 20 and 21 led to further reductions in the permeabilities of the composite filter aids. Importantly, increasing the mass ratios of the bentonite in Examples 18-21 did not lead to significant increases in the cristobalite contents.

As also illustrated in Table 6 above, increasing the calcination temperature from 700° C. to 900° C. lead to increases in permeability in Examples 11→12, 13→14, 18→19 and 20→21. However, unlike the conventional filter aids of Standard Super-Cel® and Hyflo Super-Cel®, these increases in permeability were not accompanied by a significant increase in the cristobalite contents of Examples 12, 14, 19 and 21. Thus, composite filter aids of the present disclosure are capable of achieving relative high levels of permeability and protein adsorption (due to the higher proportions of bentonite possible in, for examples, Examples 19 and 21) without containing high amounts of crystalline silica that is undesirable in many applications.

### Effects of Bentonite Proportion, Concentration and Calcination Temperature on the Permeability and Physical Properties of Composite Filter Aids

Table 7 below summarizes the compositions and process data for Examples 11-21, as well as the permeabilities, wet densities and particles distribution data for Examples 11-21 and the reference samples of the crude DE, a Standard Super-Cel® DE and a Hyflo Super-Cel® DE.

As illustrated in Table 7 below, the wet densities of the composite filter aids were indirectly related to the proportion of the bentonite relative to the amount of the diatomaceous earth used to prepare the composite filter aids. Comparing the results for Examples 11 and 12 versus the results for Examples 18 and 19 shows that increasing the mass ratio of the bentonite from 1 mass % to 3 mass % resulted in a corresponding decrease in the wet density of composite filter aids. Further increasing the proportion of the bentonite to 5 mass % in Examples 20 and 21 led to further reductions in the wet densities of the composite filter aids. It is presumed that increasing the proportion of bentonite leads to more agglomeration.

TABLE 7
Composition and Physical Properties of Composite Filter
Aids versus Convention Diatomaceous Earth Filter Aids

| | | | | | | Wet | | | |
|---|---|---|---|---|---|---|---|---|---|
| | DE^{d)} | BE^{e)} | Water | Temp. | Perm. | Density | d₁₀ | d₅₀ | d₉₀ |
| Sample ID | (g) | (g) | (g) | (° C.) | (Darcy) | (lb/cf) | (μm) | (μm) | (μm) |
| Crude DE^{d)} | n/a | | | | 0.03 | 18.9 | 8.97 | 22.91 | 65.91 |
| Standard Super-Cel ® | | | | | 0.27 | 19.0 | 10.56 | 25.07 | 78.68 |
| (calcined DE) | | | | | | | | | |
| Hyflo Super-Cel ® | | | | | 1.35 | 17.6 | 7.31 | 20.44 | 55.11 |
| (flux calcined DE) | | | | | | | | | |
| Example 11 | 100 | 1 | 50 | 700 | 0.29 | 15.4 | 9.86 | 30.07 | 83.08 |
| Example 12 | 100 | 1 | 50 | 900 | 0.39 | 15.0 | 10.68 | 32.72 | 89.07 |
| Example 13 | 100 | 1 | 75 | 700 | 0.56 | 14.8 | 12.16 | 34.58 | 86.40 |
| Example 14 | 100 | 1 | 75 | 900 | 0.75 | 14.2 | 13.15 | 37.83 | 94.87 |
| Example 15 | 400 | 4 | 400 | 600 | 1.04 | 15.8 | 14.01 | 41.02 | 89.01 |
| Example 16 | 400 | 4 | 400 | 700 | 1.22 | 16.0 | 14.04 | 41.35 | 92.27 |
| Example 17 | 400 | 4 | 400 | 800 | 2.11 | 15.2 | 15.11 | 43.75 | 94.70 |
| Example 18 | 100 | 3 | 50 | 700 | 0.24 | 15.0 | 11.10 | 36.00 | 90.72 |
| Example 19 | 100 | 3 | 50 | 900 | 0.35 | 14.0 | 11.73 | 38.42 | 99.50 |
| Example 20 | 100 | 5 | 50 | 700 | 0.23 | 14.8 | 11.12 | 36.70 | 92.13 |
| Example 21 | 100 | 5 | 50 | 900 | 0.34 | 14.5 | 11.96 | 40.77 | 107.9 |

^{d)}Crude diatomaceous earth originating from Mexico (Massive crude DE)
^{e)}Magnesium Aluminum Silicate Bentonite
n/a not applicable

As also illustrated in Table 7 above, the d₅₀ values of the composite filter aids were directly related to the proportion of the bentonite relative to the amount of the diatomaceous earth used to prepare the composite filter aids. Comparing the results for Examples 11 and 12 versus the results for Examples 18 and 19 shows that increasing the mass ratio of the bentonite from 1 mass % to 3 mass % resulted in a corresponding increase in the d₅₀ values of composite filter aids. Further increasing the proportion of the bentonite to 5 mass % in Examples 20 and 21 led to further increases in the d₅₀ values of the composite filter aids.

As also illustrated in Table 7 above, increasing the calcination temperature from 700° C. to 900° C. lead to increases in permeabilities, decreases in the wet densities, and increases in the d₅₀ values, in Examples 11→12, 13→14, 15→16→17, 18→19 and 20→21.

As also illustrated in Table 7 above, increases in wet densities, and increases in the d₅₀ values, may also be obtained by increasing the concentrations of the diatomaceous earth and bentonite used to prepare the composite filter aid. As shown in Examples 15-17, increasing water content enhanced diatomaceous earth and bentonite composite particle agglomeration and led to significantly higher permeability.

### Comparing the Pore Characteristics and Surface Areas of Composite Filter Aids Versus Convention Filter Aids

Table 8 below summarizes the compositions and process data for Examples 12 and 15, as well as the permeability, pore characteristics and surface area data for Examples 12 and 15 and the reference samples of the Standard Super-Cel® DE and the Hyflo Super-Cel® DE.

As illustrated in Table 8 below, the composite filter aids of Examples 12 and 15 have very similar permeabilities to the conventional filter aids of Standard Super-Cel® DE and Hyflo Super-Cel® DE, respectively. Relative to the Standard Super-Cel® DE filter aid, the composite filter aid of Example 12 having a similar permeability has a relatively larger pore volume, a relatively smaller pore size, and a significantly higher surface area. Relative to the Hyflo Super-Cel® DE filter aid, the composite filter aid of Example 15 having a similar permeability also has a relatively larger pore volume, a relatively smaller pore size, and a significantly higher surface area.

TABLE 8
Composition and Physical Properties of Composite Filter
Aids versus Convention Diatomaceous Earth Filter Aids

| | | | | | | Pore | Median | Surface |
|---|---|---|---|---|---|---|---|---|
| | DE^{d)} | BE^{e)} | Water | Temp. | Perm. | Volume | Pore Size | Area |
| Sample ID | (g) | (g) | (g) | (° C.) | (Darcy) | (mL/g) | (μm) | (m²/g) |
| Standard Super-Cel ® | n/a | | | | 0.27 | 3.3346 | 4.6884 | 5.1638 |
| (calcined DE) | | | | | | | | |
| Hyflo Super-Cel ® | | | | | 1.35 | 3.1291 | 9.2676 | 2.5122 |
| (flux calcined DE) | | | | | | | | |
| Example 12 | 100 | 1 | 50 | 900 | 0.39 | 3.7542 | 3.5177 | 27.4365 |
| Example 15 | 400 | 4 | 40 | 600 | 1.04 | 3.3908 | 8.3634 | 40.9147 |

^{d)}Crude diatomaceous earth originating from Mexico (Massive crude DE)
^{e)}Magnesium Aluminum Silicate Bentonite
n/a not applicable

The filtration performance of the composite filter aids of Examples 11 and 15 were also compared to the filtration performance of the convention filter aids of Standard Super-Cel® DE and Hyflo Super-Cel® DE, as shown in FIGS. 7-10. As shown in FIGS. 7 and 8, the composite filter aid of Example 11 exhibited superior filtration performance compared to Standard Super-Cel® DE. As shown in FIG. 7, the filtration pressure was much lower when using the composite filter aid of Example 11 compared to Standard Super-Cel® DE. As shown in FIG. 8, the turbidity of an Ovaltine sample filtered in the presence of the composite filter aid of Example 11 was also much lower compared to the turbidity of an Ovaltine sample filtered in the presence of Standard Super-Cel® DE. As shown in FIGS. 9 and 10, the composite filter aid of Example 15 exhibited superior filtration performance compared to Hyflo Super-Cel® DE. As shown in FIG. 9, the filtration pressure was very similar when using the composite filter aid of Example 11 to the filtration pressure when using Hyflo-Cel® Super-Cel® DE. As shown in FIG. 10, the turbidity of an Ovaltine sample filtered in the presence of the composite filter aid of Example 15 was also much lower compared to the turbidity of an Ovaltine sample filtered in the presence of Hyflo Super-Cel® DE. The enhanced filtration performance of lower pressure rise is due to the more porous structure of the composite material, and the lower turbidity is due to the smaller pore size.

### Preparation and Characterization of a Composite Filter Aids Made from Perlite and Bentonite

Table 9 below summarizes the permeability and wet density for Perlite/Bentonite composite filter aids prepared generally as the DE examples in the earlier examples but with perlite substituted for the DE. The perlites used were HARBORLITE® 400 (Perlite 1) and the HARBORLITE® 900s (Perlite 2).

TABLE 9
Composition and Filtration Properties of Perlite/Bentonite
Composite Filter Aids

| | | | | Sodium | | | Wet |
|---|---|---|---|---|---|---|---|
| Sample | Perlite 1 | Perlite 2 | Bentonite | Silicate | Water | Permeability | Density |
| ID | (g) | (g) | (g) | (g) | (g) | (Darcy) | (lb/cf) |
| Example | 25 | 0 | 75 | 10 | 20 | 0.14 | 26 |
| 16 | | | | | | | |
| Example | 50 | 0 | 50 | 10 | 20 | 0.24 | 22.3 |
| 17 | | | | | | | |
| Example | 75 | 0 | 25 | 10 | 20 | 0.58 | 18.1 |
| 18 | | | | | | | |
| Example | 0 | 25 | 75 | 10 | 20 | 0.39 | 25 |
| 19 | | | | | | | |
| Example | 0 | 50 | 50 | 10 | 20 | 1.63 | 21.2 |
| 20 | | | | | | | |
| Example | 0 | 75 | 25 | 10 | 20 | 5.10 | 17.1 |
| 21 | | | | | | | |
| Example | 0 | 100 | 0 | 0 | 0 | 1.95 | 14.7 |
| 22 | | | | | | | |
| Example | 100 | 0 | 0 | 0 | 0 | 0.16 | 17.8 |
| 23 | | | | | | | |

Table 10 below compares the BET surface area of Perlite 2 to the bentonite and to the perlite/bentonite composite filter aid from example 20. As can be seen in the table, the perlite/bentonite composite filter aid has a significantly higher BET surface area than the perlite alone.

TABLE 10
Composition and Filtration Properties of
Perlite/Bentonite Composite Filter Aids

| Sample ID | Surface area (m²/g) |
|---|---|
| Perlite (H900S) | 1.6 |
| Bentonite | 71.5 |
| Perlite and bentonite composite | 11.8 |

The above description is presented to enable a person skilled in the art to make and use the invention, and is provided in the context of a particular application and its requirements. Various modifications to the embodiments disclosed herein will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the disclosure may not show every benefit of the invention, considered broadly.

1. A composite filter aid, comprising a structured composite material formed by agglomerating a mineral with a protein-adsorbing binder, wherein:
the structured composite material comprises a particle of the protein-adsorbing binder bonded to a plurality of particles of the mineral;
a permeability of the structured composite material is greater than a permeability of the mineral; and
the permeability of the structured composite material is greater than a permeability of the protein-adsorbing binder.

2-4. (canceled)

5. The composite filter aid of claim 1, wherein the mineral is a biogenic mineral is selected from the group consisting of a natural diatomaceous earth, a modified diatomaceous earth, and mixtures thereof.

6. The composite filter aid of claim 1, wherein the mineral is a nature glass selected from the group consisting of a perlite, a volcanic ash, a pumice, a shirasu, an obsidian, a pitchstone, a rice hull ash, and mixtures thereof.

7. The composite filter aid of claim 1, wherein the protein-adsorbing binder is a phyllosilicate mineral selected from the group consisting of a serpentine mineral, a clay mineral, a mica mineral and a chlorite mineral.

8. The composite filter aid of claim 1, wherein the protein-adsorbing binder is a phyllosilicate mineral selected from the group consisting of an antigorite (Mg₃Si₂O₅(OH)₄), a chrysotile (Mg₃Si₂O₅(OH)₄), a lizardite (Mg₃Si₂O₅(OH)₄), a halloysite (Al₂Si₂O₅(OH)₄), an kaolinite (Al₂Si₂O₅(OH)₄), an illite ((K,H₃O) (Al,Mg,Fe)₂(Si,Al)₄O₁₀[(OH)₂.(H₂O)]), a montmorillonite ((Na,Ca)_{0.33}(Al,Mg)₂Si₄O₁₀ (OH)₂.nH₂O), a vermiculite ((MgFe,Al)₃(Al,Si)₄O₁₀(OH)₂.4H₂O), a talc (Mg₃Si₄O₁₀(OH)₂), a sepiolite (Mg₄Si₆O₁₅(OH)₂.6H₂O), a palygorskite ((Mg,Al)₂Si₄O₁₀ (OH).4(H₂O)), an attapulgite ((Mg,Al)₂Si₄O₁₀ (OH).4(H₂O)), a pyrophyllite (Al₂Si₄O₁₀(OH)₂), a biotite (K(Mg,Fe)₃ (AlSi₃)O₁₀(OH)₂), a muscovite (KAl₂(AlSi₃) O₁₀(OH)₂), a phlogopite (KMg₃ (AlSi₃)O₁₀(OH)₂), a lepidolite (K(Li,A)₂₋₃(AlSi₃) O₁₀(OH)₂), a margarite (CaAl₂ (Al₂Si₂)O₁₀(OH)₂), a glauconite ((K,Na) (Al,Mg,Fe)₂(Si,Al)₄O₁₀ (OH)₂), a chlorite ((Mg,Fe)₃(Si,Al)₄O₁₀(OH)₂. (Mg,Fe)₃(OH)₆), and mixtures thereof.

9. The composite filter aid of claim 1, wherein the phyllosillcate is selected from the group consisting of a sodium bentonite, a calcium bentonite, a potassium bentonite, and mixtures thereof.

10. The composite filter aid of claim 1, wherein the structured composite material is formed by agglomerating the mineral with the protein-adsorbing binder in the presence of an additional binder that is different from the mineral and the protein-adsorbing binder.

11-15. (canceled)

16. The composite filter aid of claim 1, wherein a mass ratio of the protein-adsorbing binder to the mineral ranges from about 0.01:99.99 to about 50:50.

17. The composite filter aid of claim 1, having a crystalline silica level of less than about 1% by weight.

18. The composite filter aid of claim 1, wherein:
a d₅₀ of structured composite material is greater than a d₅₀ of the mineral; and
a wet density of the structured composite material is less than a wet density of the mineral.

19. The composite filter aid of claim 1, wherein a ratio of a cation exchange capacity of the composite filter aid to a cation exchange capacity of the protein-absorbing binder ranges from about 0.95:1.05 to about 1.05:0.95.

20. The composition filter aid of claim 1, wherein the composite filter aid has:
a permeability ranging from about 0.01 darcy to about 50 darcys;
a wet density ranging from about 12 lb/ft³ to about 22 lb/ft³;
a d₅₀ ranging from about 20 microns to about 70 microns;
a pore volume ranging from about 2.0 mL/g to about 6.0 mL/g;
a median pore size ranging from about 1.0 microns to about 10.0 microns; and
a BET surface area ranging from about 3.0 m²/g to about 70.0 m²/g.

21. A structured composite material, comprising a mineral bound to a phyllosilicate, wherein a mass ratio of the phyllosilicate to the mineral is set such that:
(i) a permeability of the structured composite material is greater than permeabilities of the mineral and the phyllosilicate;
(ii) a d₅₀ of the structured composite material is greater than a d₅₀ of the mineral;
(Iii) a wet density of the structured composite material is less than a wet density of the mineral; and
(iv) the structured composite material has a crystalline silica level of less than about 1% by weight.

22. The structured composite material of claim 21, wherein the mineral is at least one selected from the group consisting of a biogenic mineral and a natural glass.

23. The structured composite material of claim 21, wherein the mineral is a biogenic mineral is selected from the group consisting of a natural diatomaceous earth, a modified diatomaceous earth, and mixtures thereof.

24. The structured composite material of claim 21, wherein the mineral is a nature glass selected from the group consisting of a perlite, a volcanic ash, a pumice, a shirasu, an obsidian, a pitchstone, a rice hull ash, and mixtures thereof.

25. The structured composite material of claim 21, wherein the phyllosilicate is selected from the group consisting of a sodium bentonite, a calcium bentonite, a potassium bentonite, and mixtures thereof.

26. The structured composite material of claim 21, wherein:
the structured composite material is formed by agglomerating the mineral with the phyllosilicate in the presence of a binder that is different from the mineral and the phyllosilicate; and
the binder is at least one selected from the group consisting of an inorganic binder and an organic binder.

27. The structured composite material of claim 21, wherein the mass ratio ranges from about 0.01:99.99 to about 50:50.

28-46. (canceled)
